(19) United States
(12) Patent Application Publication
(10) Pub. No.: US 2024/0255683 A1
(43) Pub. Date: Aug. 1, 2024

(54) OPTICAL FILTER

(71) Applicant: LMS CO., LTD., Pyeongtaek-si (KR)

(72) Inventors: Joon Ho JUNG, Pyeongtaek-si (KR); Nam Woo KANG, Pyeongtaek-si (KR); Sun Jung KIM, Pyeongtaek-si (KR)

(21) Appl. No.: 18/426,397

(22) Filed: Jan. 30, 2024

(30) Foreign Application Priority Data
Jan. 30, 2023 (KR) 10-2023-0011616

(51) Int. Cl. G02B 5/22

(52) U.S. Cl. CPC G02B 5/223

(57) ABSTRACT

This invention provides an optical filter and its use. In the present invention, an optical filter capable of securing high transmittance in a necessary wavelength range (e.g., visible light region) while effectively blocking light in an unnecessary wavelength range (e.g., ultraviolet, and infrared ray) and its utilization can be provided.

### CROSS-REFERENCE TO RELATED APPLICATION(S)

This application is based on and claims priority under 35 U.S.C. 119 to Korean Patent Application No. 10-2023-0011616, filed on Jan. 30, 2023, in the Korean Intellectual Property Office, the disclosure of which is herein incorporated by reference in its entirety.

### TECHNICAL FIELD

This application relates to an optical filter and an image capturing device.

### BACKGROUND

An optical filter is used in an image capturing device using a charge-coupled device (CCD) or a complementary metal oxide semiconductor (CMOS) image sensor. Such an optical filter is also called as a near-infrared cut filter and is used to obtain good color reproducibility and sharp images.

Various characteristics are required for such an optical filter. The optical filter must effectively block ultraviolet and infrared light and transmit visible light with high transmittance.

Therefore, a rapid and sharp change in transmittance is required at the boundary between ultraviolet rays and visible light to be blocked and at the boundary between infrared and visible light.

The optical filter is necessary to maintain the transmission and blocking characteristics as described above even when the incident angle changes. As wide-angle cameras are developed, these characteristics become more important, and the necessity for an optical filter maintaining transmission and blocking characteristics even at a wider angle of incidence is increasing.

To manufacture an optical filter having the above function, the optical filter is usually manufactured to have a multilayer structure. That is, for the optical filter to transmit light of a desired wavelength and block unnecessary light, the optical filter usually includes a dielectric multilayer film and/or a light absorption layer.

The dielectric multilayer film described above is usually a film formed by repeatedly stacking a high refractive index dielectric material and a low refractive index dielectric material, and such a film can block light of unnecessary wavelengths by reflection according to its design.

The light absorption layer is a film designed to block light of an unnecessary wavelength by absorption using various dyes. Light at a target wavelength can be blocked by appropriately forming the dielectric multilayer film and/or the light absorption layer as described above on the optical filter.

However, when an optical filter is formed in a multilayer structure, unnecessary reflection and/or absorption occurs at the interface between layers. Such reflection and/or absorption occur in a wavelength region in which the optical filter should exhibit high transmittance (e.g., visible light wavelength region) causes low transmittance.

Recently, an optical filter using so-called infrared absorbing glass (also called blue glass) having a near-infrared absorbing property as a substrate is also known. Infrared absorbing glass is a glass filter in which CuO is added to glass to selectively absorb light in the near infrared wavelength region.

The use of such an infrared absorbing glass has the advantage of being able to block light more effectively in an unnecessary wavelength range, but since the substrate itself exhibits absorption characteristics, problems arise from reflection and/or absorption occurring between the layers. There is a disadvantage in that the transmittance decrease problem becomes larger.

### SUMMARY

An object of the present invention is to provide an optical filter and its use. Another object of the present invention is to provide an optical filter and its use capable of securing high transmittance in a necessary wavelength range (e.g., visible light region) while effectively blocking light in an unnecessary wavelength range (e.g., ultraviolet and infrared light).

According to an embodiment of the invention, there is provided that an optical filter comprises a substrate; and a transmittance control layer formed on one or both surfaces of the substrate wherein an absolute value of a difference in a refractive index of the transmittance control layer with respect to a refractive index of the substrate is in a range of 2% to 10% and ΔT₁ is 0.5% or more in Equation 1:

$$Δ {T}_{1} = 100 \times ( {T}_{F 1} - {T}_{S 1} ) / {T}_{S 1} \qquad [ Equation 1 ]$$

In Equation 1, wherein T_{F1} is an average transmittance in a wavelength range of 481 nm to 560 nm of the optical filter, and T_{S1} is an average transmittance in the wavelength range of 481 nm to 560 nm of the optical filter not including the transmittance control layer.

In an embodiment, T_{F1} in Equation 1 is 80% or more for the optical filter in the present invention.

In an embodiment, the substrate is a glass substrate for the optical filter in the present invention.

In an embodiment, the glass substrate contains copper in an amount of about 10% by weight or less for the optical filter in the present invention.

In an embodiment, the transmittance control layer comprises at least one selected from a group consisted of a cyclic olefin polymer resin (COP), polyarylate, polyisocyanate, polyimide, polyetherimide, polyamideimide, polyacrylate, polyester, polysulfone, polysilazane, and polysiloxane for the optical filter in the present invention.

In an embodiment, the refractive index of the substrate is greater than the refractive index of the transmittance control layer and the refractive index of the substrate is in the range of about 1.48 to 1.6 for the optical filter in the present invention.

In an embodiment, the transmittance control layers are formed on both sides of the substrate for the optical filter in the present invention.

In an embodiment, the optical filter further comprises a light absorption layer in the present invention.

In an embodiment, an absolute value of a difference in a refractive index of the light absorption layer with respect to the refractive index of the substrate is in a range of about 0.2% to 10% for the optical filter having the light absorption layer in the present invention.

In an embodiment, the optical filter having the light absorption layer further comprises a pressure-sensitive adhesive layer, an adhesive layer, or a primer layer between the light absorption layer and the substrate in the present invention.

In an embodiment, the transmittance control layer is located on a surface opposite to the surface of the substrate on which the pressure-sensitive adhesive layer, the adhesive layer, or the primer layer is formed or the transmittance control layer is located on a surface opposite to the surface of the light absorption layer on which the pressure-sensitive adhesive layer, the adhesive layer, or the primer layer is formed for the optical filter having the light absorption layer in the present invention.

In an embodiment, a difference in the refractive index of the light absorption layer with respect to the refractive index of the substrate is in a range of about 0.2% to 2%; a difference in a refractive index of the pressure-adhesive adhesive layer, the adhesive layer, or the primer layer with respect to the refractive index of the substrate is in a range of about 3% to 10%; and a difference in the refractive index of the pressure-sensitive adhesive layer, the adhesive layer, or the primer layer with respect to the refractive index of the transmittance control layer is within a range of about 8% to 15% for the optical filter having the light absorption layer in the present invention.

In an embodiment, a difference in the refractive index of the transmittance control layer with respect to the refractive index of the substrate is in a range of about −2% to −10% for the optical filter having the light absorption layer in the present invention.

In an embodiment, the light absorption layer is in direct contact with the pressure-sensitive adhesive layer, the adhesive layer, or the primer layer each other; the substrate is in direct contact with the pressure-sensitive adhesive layer, the adhesive layer, or the primer layer each other; and the transmittance control layer is in direct contact with the light absorption layer or the substrate for the optical filter having the light absorption layer in the present invention.

In an embodiment, the optical filter further comprises a first and a second light absorption layers having different refractive indices each other wherein the transmittance control layer is formed on a surface opposite to the surface of the substrate on which the first light absorption layer is formed or the transmittance control layer is formed on a surface of the second light absorption layer opposite to the surface on which the first light absorption layer is formed in the present invention.

In an embodiment, the first light absorption layer has a lower refractive index than the second light absorption layer and the first light absorption layer is located between the second light absorption layer and the substrate for the optical filter in the present invention.

In an embodiment, a difference in the refractive index of the first light absorption layer with respect to the refractive index of the substrate is in a range of about −2% to −10% and a difference in the refractive index of the second light absorption layer with respect to the refractive index of the substrate is in a range of about 2% to 10% for the optical filter having the light absorption layer in the present invention.

In an embodiment, a difference in the refractive index of the transmittance control layer with respect to the refractive index of the substrate is in a range of about −2% to −10% for the optical filter having the light absorption layer in the present invention.

In an embodiment, the second light absorption layer is in direct contact with the first light absorption layer each other; the first light absorption layer is in direct contact with the substrate each other; and the transmittance control layer is in direct contact with the second light absorption layer or the substrate for the optical filter having the light absorption layer in the present invention.

In an embodiment, the optical filter further comprises a dielectric multilayer film formed on one or both surfaces of the substrate in the present invention.

According to another embodiment in the present invention, an optical filter comprises a first layer, a second layer, a third layer and a fourth layer sequentially stacked wherein refractive indices of the first to fourth layers are n₁, n₂, n₃ and n₄, respectively; a substrate which is any one of the first to fourth layers; and a transmittance control layer which is any one of the first to fourth layers wherein refractive indices n₁ to n₄ satisfy a relationship of Equation 4 or 5:

$${n}_{2} > {n}_{1} \geq {n}_{3} > {n}_{4} \qquad [ Equation 4 ]$$

$$and$$

$${n}_{2} > {n}_{3} \geq {n}_{1} > {n}_{4} , \qquad [ Equation 5 ]$$

wherein an average refractive index of the first to fourth layers is in a range of 1.3 to 1.9; and an absolute value of a difference between an average refractive index of the first and third layers and an average refractive index of the second and fourth layers is in a range of 0 to 2.

According to another embodiment in the present invention, an optical filter comprises a first layer, a second layer, a third layer and a fourth layer sequentially stacked wherein refractive indices of the first to fourth layers are n₁, n₂, n₃ and n₄, respectively; a substrate which is any one of the first to fourth layers; and a transmittance control layer which is any one of the first to fourth layer wherein an average refractive index nᵥ of the first to fourth layers is in a range of 1.3 to 1.9 and satisfies Equation 6 or 7:

$${n}_{v} - {n}_{1} > 0 , \qquad [ Equation 6 ]$$

$${n}_{v} - {n}_{2} < 0 ,$$

$${n}_{v} - {n}_{3} > 0$$

$$and$$

$${n}_{v} - {n}_{4} < 0 ;$$

$$and$$

$${n}_{v} - {n}_{1} < 0 , \qquad [ Equation 7 ]$$

$${n}_{v} - {n}_{2} > 0 ,$$

$${n}_{v} - {n}_{3} < 0$$

$$and$$

$${n}_{v} - {n}_{4} > 0.$$

### BRIEF DESCRIPTION OF THE DRAWINGS

FIGS. 1 to 3 are schematics showing an exemplary structure of an optical filter of the present invention.

FIG. 4 is a spectrum showing transmittance characteristics of the optical filter of Embodiment 8.

FIG. 5 is a spectrum showing transmittance characteristics of the optical filter of Embodiment 9.

### DETAILED DESCRIPTION

Various embodiments and terms used in the specification are not intended to limit the technical features described in the specification to specific embodiments, but it should be understood to include various modifications, equivalents, or substitutions of the embodiments. In connection with the description of the drawings, similar reference numerals may be used for similar or related components. The singular form of the noun corresponding to the item may include one or more of the elements unless the relevant context clearly dictates otherwise.

Embodiments will be described with reference to the associating drawings. In describing the present embodiment, the same names and the same reference numerals are used for the same components, and an additional description thereof will be omitted. In addition, in describing the embodiment of the present invention, the same names and reference numerals are used for components having the same functions, and it is substantially not completely the same as in the prior art.

According to various embodiments, terms such as “comprise” or “have” are intended to designate the presence of a feature, number, step, operation, component, part, or combination described in the specification. It should be understood, however, that the above does not preclude the possibility of addition or existence of one or more of other features, or numbers, steps, operations, components, parts, or combinations.

For those physical properties mentioned in the present invention where the result of measuring temperature may affect, it is measured at room temperature unless otherwise specified. The term “room temperature” used in the present invention refers to a natural temperature that is not heated or not reduced, for example, it means any temperature within the range of 10° C. to 30° C., a temperature of about 23° C. or about 25° C. In addition, in the present specification, the unit of temperature is Celsius (° C.) unless otherwise specified.

The term “atmospheric pressure” is a natural pressure that is not pressurized or depressurized. It usually means about 1 atmosphere of atmospheric pressure having the value of about 740 mmHg to 780 mmHg. In the case of a physical property in which the measured humidity affects the result, the physical property is a physical property measured at natural humidity that is not specifically controlled at the room temperature and/or atmosphere pressure.

In the case where an optical characteristic (e.g., refractive index) referred to in the present invention is a characteristic that varies depending on the wavelength, the optical characteristic is a result obtained for light having a wavelength of 520 nm unless otherwise specified.

The term “transmittance” or “reflectance” used in the present invention means an actual transmittance (measured transmittance) or an actual reflectance (measured reflectance) confirmed at a specific wavelength unless otherwise specified.

The term “transmittance” or “reflectance” used in the present invention is a value measured using an ultraviolet and visible spectrophotometer and means the transmittance or the reflectance for light at an incident angle of 0° based on the normal of the measurement target surface unless the incident angle is specifically specified.

In the present invention, the term “average transmittance” is a result of obtaining an arithmetic average of the measured transmittance after measuring transmittance of each wavelength while increasing the wavelength by 1 nm from the shortest wavelength within a predetermined wavelength region unless otherwise specified. For example, the average transmittance within the wavelength range of 350 nm to 360 nm is an arithmetic average of transmittance measured at the wavelength of 350 nm, 351 nm, 352 nm, 353 nm, 354 nm, 355 nm, 356 nm, 357 nm, 358 nm, 359 nm, and 360 nm.

In the present specification, the term “maximum transmittance” refers to the maximum transmittance when the transmittance of each wavelength is measured while increasing the wavelength by 1 nm from the shortest wavelength within a predetermined wavelength region. For example, the maximum transmittance within the wavelength range of 350 nm to 360 nm is the highest transmittance among transmittances measured at the wavelength of 350 nm, 351 nm, 352 nm, 353 nm, 354 nm, 355 nm, 356 nm, 357 nm, 358 nm, 359 nm, and 360 nm.

In the present specification, the term “minimum transmittance” refers to the minimum transmittance when the transmittance of each wavelength is measured while increasing the wavelength by 1 nm from the shortest wavelength within a predetermined wavelength region. For example, the minimum transmittance within the wavelength range of 350 nm to 360 nm is the lowest transmittance among transmittances measured at the wavelength of 350 nm, 351 nm, 352 nm, 353 nm, 354 nm, 355 nm, 356 nm, 357 nm, 358 nm, 359 nm, and 360 nm.

The term “incident angle” used in the present invention is an angle normal to a surface to be evaluated. For example, a transmittance at an incident angle of 0° of the optical filter means the transmittance for light incident in a direction parallel to the normal of the optical filter surface. Also, a transmittance at an incident angle of 40° is the transmittance for the incident light forming an angle of 40° in the clockwise or the counterclockwise direction with respect to the normal of the optical filter surface. This definition of the incident angle is equally applied to other characteristics such as transmittance.

The optical filter layer of the present invention can efficiently and accurately block ultraviolet light near the short-wavelength visible light region and the infrared light near the long-wavelength visible light region and implement a visible light transmission band with high transmittance. The optical filter of the present invention may include a transparent substrate, and a so-called infrared absorbing substrate may be applied as the transparent substrate.

In the present specification, when a substrate or a layer is transparent, it means a case where the substrate or layer exhibits transmittance of a certain level or higher at a wavelength of about 550 nm. For example, the lower limit of the transmittance of the transparent substrate or the transparent layer at a wavelength of 550 nm may be about 50%, 55%, 60%, 65%, 70%, 75%, 80% or 85%, and the upper limit may be about 100%, 95%, 90%, 85%, 80%, 75%, 70%, 65% or 60%. The transmittance may be greater than or greater than equal to the lower limit of any one of the lower limits described above, or less than or less than equal to the upper limit of any one of the upper limits described above, or within a range of greater than or greater than equal to the lower limit of any one of the lower limits described above and less than or less than equal to any one of the upper limits described above.

As the transparent substrate, a common substrate used as a substrate for an optical filter may be used without limitation. As the substrate, a substrate that exhibits appropriate transmittance and has appropriate rigidity capable of maintaining the shape of the optical filter is usually used. For example, a substrate made of an inorganic material such as glass or crystal or an organic material such as resin can be used.

Resin materials usable for the transparent substrate can be exemplified to include polyesters such as polyethylene terephthalate (PET) or polybutylene terephthalate (PBT), polyolefins such as polyethylene, polypropylene, or ethylene-vinyl acetate copolymer (EVA), norbornene polymer, acrylic polymer such as PMMA (poly(methyl methacrylate)), urethane polymer, vinyl chloride polymer, fluorine polymer, polycarbonate, polyvinyl butyral, polyvinyl alcohol or polyimide but are not limited to.

Examples of the glass material that can be used for the transparent substrate include soda lime glass, borosilicate glass, alkali free glass, and quartz glass. Crystal materials that can be used for the transparent substrate include birefringent crystals such as quartz, lithium niobate, or sapphire.

If necessary, a so-called infrared absorbing substrate may be used as the transparent substrate. The infrared absorbing substrate is a substrate that exhibits absorption characteristics in at least a part of the infrared region. A so-called blue glass exhibiting the above characteristics by including copper is a representative example of the infrared absorbing substrate. Such an infrared absorbing substrate is useful in constructing an optical filter that blocks light in the infrared region but is disadvantageous in securing high transmittance in the visible region due to the absorption characteristics. In the present specification, it is possible to provide an optical filter exhibiting high transmittance characteristics in the visible light region while efficiently blocking light in a desired ultraviolet and infrared region by selecting an infrared absorbing substrate.

As the infrared absorbing substrate, a substrate known as so-called infrared absorbing glass can be used. Such glass is an absorption type glass manufactured by adding such as CuO to a fluorophosphate-based glass or phosphate-based glass. Therefore, for one example, as the infrared absorbing substrate, a CuO-containing fluorophosphate glass substrate or a CuO-containing phosphate glass substrate may be used in the present specification. The phosphate glass includes silicophosphate glass in which a part of the frame of the glass is composed of SiO₂. Such absorption-type glass is known in public, and for example, the glass disclosed in Korean Patent Registration No. 10-2,056,613 or other commercially available absorption-type glass (e.g., commercially available products such as Hoya, Short, PTOT) may be used.

The transparent substrate (e.g., glass substrate) may include copper. For example, the upper limit of the copper content included in the transparent substrate may be about 10 wt %, 9 wt %, 8 wt %, or 7 wt %, and the lower limit may be 0 wt %, 1 wt %, and 2 wt %, 3 wt %, 4 wt %, 5 wt %, 6 wt % or 7 wt %. The copper content may be greater than or greater than equal to any one of the lower limits described above, or less than or less than equal to any one of the upper limits described above, or within a range of greater than or greater than equal to any one of the lower limits described above and less than or less than equal to any one of the upper limits described above. Since copper is not included when the transparent substrate (e.g., glass substrate) is not a conventional substrate, in other words, it is not an infrared absorbing substrate, the lower limit of the copper content may be 0 wt %.

The substrate may have a refractive index within a predetermined range. For example, the lower limit of the refractive index of the substrate may be about 1.48, 1.5, or 1.52 and the upper limit may be about 1.6, 1.58, 1.56, 1.54, or 1.52. The refractive index may be greater than or greater than equal to any one of the lower limits described above, or less than or less than equal to any one of the upper limits described above, or within a range of greater than or greater than equal to any one of the lower limits described above and less than or less than equal to any one of the upper limits described above.

The thickness of the transparent substrate as described above may be adjusted within a range of about 0.03 mm to about 5 mm but is not limited.

The optical filter of the present invention may include a transmittance control layer together with the substrate. In the specification, the term “transmittance control layer” refers to a layer where the transmittance of an optical filter varies depending on the presence or absence of the corresponding layer. Specifically, the transmittance control layer has a predetermined refractive index relationship with the substrate which will be described later. It may also refer to a layer that allows an optical filter having the transmittance control layer to exhibit higher visible light transmittance compared to an optical filter without the control layer. In this case, the visible light transmittance is the average transmittance in the wavelength range of about 481 nm to 560 nm.

For one example, the transmittance control layer may refer to a layer where an absolute value of a difference between a refractive index of the transmittance control layer and a refractive index of the substrate is within a certain range. In this specification, the difference between the refractive index of B to the refractive index of A is a calculated difference as 100×(n_{B}−n_{A})/n_{A}, where n_{A} is the refractive index of A and n_{B} is the refractive index of B.

The lower limit of the absolute value of the difference between the refractive index of the transmittance control layer and the refractive index of the substrate may be about 2%, 3%, or 4%, and the upper limit may be about 10%, 9%, 8%, 7%, or 6%. % or 5%. The absolute value may be greater than or greater than equal to any one of the lower limits as stated above, or less than or less than equal to any one of the upper limits as stated above, or within a range of greater than or greater than equal to any one of the lower limits as stated above and less than or less than equal to any one of the upper limits as stated above.

The transmittance control layer may have a higher refractive index or a lower refractive index than the substrate as long as the refractive index relationship with respect to the substrate is shown as stated above. Although the reason for the transmittance of the optical filter being increased by including the transmittance control layer is not clear, it is understood that an appropriately repeated laminated structure of a high refractive index region and a low refractive index region is formed in the optical filter depending on the position of the transmittance control layer in the optical filter and consequently, reflection and absorption of light of a specific wavelength occurring between layers due to phenomena such as destructive interference by such a structure is alleviated, canceled, prevented, or suppressed.

Due to the presence of the transmittance control layer in the optical filter, the optical filter may exhibit higher transmittance than that of the transparent substrate within a predetermined wavelength range. For example, in the optical filter, ΔT₁ of Equation 1 below may be within a predetermined range.

$$Δ {T}_{1} = 100 \times ( {T}_{F 1} - {T}_{S 1} ) / {T}_{S 1} \qquad [ Equation 1 ]$$

In Equation 1, T_{F1} is the average transmittance in the wavelength range of 481 nm to 560 nm of the optical filter including the transmittance control layer, and T_{S1} is the average transmittance in the wavelength range of 481 nm to 560 nm of the optical filter not including the transmittance control layer. The optical filter of the transmittance T_{S1} is the same as the optical filter having the transmittance T_{F1} except that the transmittance control layer is not included.

The lower limit of ΔT₁ in Equation 1 may be 0.5%, 1%, 1.5%, 2%, 2.5% or 3%, and the upper limit may be 10%, 9.5%, 9%, 8.5%, 8%, 7.5%, 7%, 6.5%, 6%, 5.5%, 5%, 4.5%, 4%, 3.5%, 3%, 2.5%, 2%, 1.5% or 1%. ΔT₁ may be greater than or greater than equal to any one of the lower limits described above, or less than or less than equal to any one of the upper limits described above, or within a range of greater than or greater than equal to any one of the lower limits described above and less than or less than equal to any one of the upper limits described above.

In Equation 1, the lower limit of T_{F1} may be about 80%, 82%, 84%, 86%, 88%, or 89%, and the upper limit may be about 100%, 95%, or 90%. The T_{F1} may be greater than or greater than equal to any one of the lower limits described above, or less than or less than equal to any one of the upper limits described above, or within a range of greater than or greater than equal to any one of the lower limits described above and less than or less than equal to any one of the upper limits described above.

For example, in the optical filter, ΔT₂ of Equation 2 below may be within a predetermined range.

$$Δ {T}_{2} = 100 \times ( {T}_{F 2} - {T}_{S 2} ) / {T}_{S 2} \qquad [ Equation 2 ]$$

In Equation 2, T_{F2} is the average transmittance in the wavelength range of 466 nm to 480 nm of the optical filter including the transmittance control layer, and T_{S2} is the average transmittance in the wavelength range of 466 nm to 480 nm of the optical filter without the transmittance control layer. The optical filter of the transmittance T_{S2} is the same as the optical filter having the transmittance T_{F2} except that the transmittance control layer is not included.

The lower limit of ΔT₂ in Equation 2 may be 0.5%, 1%, 1.5%, 2%, 2.5%, 3% or 3.5%, and the upper limit may be 10%, 9.5%, 9%, 8.5%, 8%, 7.5%, 7%, 6.5%, 6%, 5.5%, 5%, 4.5%, 4%, 3.5%, 3%, 2.5%, 2%, 1.5% or 1%. ΔT₂ may be greater than or greater than equal to any one of the lower limits described above, or less than or less than equal to any one of the upper limits described above, or within a range of greater than or greater than equal to any one of the lower limits described above and less than or less than equal to any one of the upper limits described above.

In Equation 2, the lower limit of T_{F2} may be about 80%, 82%, 84%, 86%, 88% or 89%, and the upper limit may be about 100%, 95% or 90%. The T_{F2} may be greater than or greater than equal to any one of the lower limits described above, or less than or less than equal to any one of the upper limits described above, or within a range of greater than or greater than equal to any one of the lower limits described above and less than or less than equal to any one of the upper limits described above.

For example, in the optical filter, ΔT₃ of Equation 3 below may be within a predetermined range.

$$Δ {T}_{3} = 100 \times ( {T}_{F 3} - {T}_{S 3} ) / {T}_{S 3} \qquad [ Equation 3 ]$$

In Equation 3, T_{F3} may be the average transmittance in the wavelength range of 425 nm to 465 nm of the optical filter including the transmittance control layer, and T_{S3} is the average transmittance in the wavelength range 425 nm to 465 nm of the optical filter without the transmittance control layer. The optical filter of the transmittance T_{S3} is the same as the optical filter having the transmittance T_{F3} except that the transmittance control layer is not included.

The lower limit of ΔT₃ in Equation 3 may be 0.5%, 1%, 1.5%, 2%, 2.5%, 3% or 3.3%, and the upper limit may be 10%, 9.5%, 9%, 8.5%, 8%, 7.5%, 7%, 6.5%, 6%, 5.5%, 5%, 4.5%, 4%, 3.5%, 3%, 2.5%, 2%, 1.5% or 1%. ΔT₃ may be greater than or greater than equal to any one of the lower limits described above, or less than or less than equal to any one of the upper limits described above, or within a range of greater than or greater than equal to any one of the lower limits described above and less than or less than equal to any one of the upper limits described above.

In Equation 3, the lower limit of T_{F3} may be 65%, 70%, 75%, 80%, 85% or 90%, and the upper limit may be 100%, 95%, 90%, 85%, 80% or 75%. T_{F3} may be greater than or greater than equal to any one of the lower limits described above, or less than or less than equal to any one of the upper limits described above, or within a range of greater than or greater than equal to any one of the lower limits described above and less than or less than equal to any one of the upper limits described above.

The transmittance control layer is a layer of a different type from the dielectric multilayer film and light absorption layer included in the normal optical filter. Accordingly, the transmittance control layer may be a single layer unlike the dielectric multilayer. In addition, unlike the light absorption layer, the transmittance control layer does not substantially include an absorbent (colorant, etc.) such as a so-called ultraviolet absorbent and an infrared absorbent.

For example, the amount of the absorbent in the transmittance control layer may be 1 wt % or less, 0.5 wt % or less, 0.1 wt % or less, 0.05 wt % or less, 0.01 wt % or less, 0.005 wt % or less, or 0.001 wt % or less. The lower limit may be about 0 wt %.

The type of material forming the transmittance control layer may not be particularly limited as long as it can form the above-described transparent layer and exhibit the above-described refractive index relationship with respect to the substrate. For one example, the transmittance control layer may include polysilazane, silica (SiOₓ), a silane compound, cyclic olefin polymer resin (COP), polysilsesquioxane, polyarylate, polyisocyanate, polyimide, polyetherimide, polyamideimide, polyacrylate, polyester, polycarbonate, polyethylenephthalate, epoxy resin, polysulfone, urethane resin, silicone resin, polysiloxane, polysilane, polycarbosilane, fluorine resin, and one or two or more selected from a group consisting of silane compounds as the material. For example, the transmittance control layer may include organic or inorganic polysilazane as the polysilazane. As it is well known in public, inorganic and organic polysilazanes can be distinguished by whether a functional group substituted for a silicon atom or a nitrogen atom of polysilazane contains carbon.

The transmittance control layer may include additives required in addition to the material. For example, it may include other additives such as a curing agent or a surfactant.

The transmittance control layer may have a thickness within an appropriate range. For example, the lower limit of the thickness of the transmittance control layer may be about 1 nm, 5 nm, 10 nm, 15 nm, 20 nm, 50 nm, 100 nm, 110 nm or 120 nm, and the upper limit may be 1,000 nm, 500 nm, 250 nm, 200 nm, 150 nm, 100 nm, 80 nm, 60 nm, 40 nm, or 25 nm. The thickness may be greater than or greater than equal to any one of the lower limits described above, or less than or less than equal to any one of the upper limits described above, or within a range of greater than or greater than equal to any one of the upper limits described above and less than or less than equal to any one of the upper limits described above.

The transmittance control layer as described above may be formed on one side or both sides of the substrate. In addition, the transmittance control layer may be formed in contact with the substrate, or another layer may be present between the substrate and the transmittance control layer.

The optical filter of the present invention includes the substrate and the transmittance control layer and may further include a publicly known layer. For example, the optical filter may further include an absorption layer formed on one or both surfaces of the substrate and/or the transmittance control layer. The absorption layer is a light absorption layer, and, for example, it is a layer absorbing light within at least a part of a wavelength range in the infrared and/or ultraviolet region. The absorption layer may be formed in one layer or two or more layers in the optical filter.

The absorption layer may be an infrared absorption layer and/or an ultraviolet ray absorption layer. The absorption layer may also be a layer having both infrared absorbing and ultraviolet absorbing properties. These layers are usually layers containing an absorbent (colorant, pigment, dye, etc.) and a transparent resin, and may be applied to implement a sharper transmittance band by cutting light in the near-ultraviolet region and/or near-infrared region. Such an absorption layer may also be the transparent layer.

For one example, the ultraviolet absorption layer may be designed to exhibit a maximum absorption in a wavelength range of about 300 nm to 390 nm. The infrared absorption layer may be designed to exhibit an absorption maximum in a wavelength range of 600 nm to 800 nm. For one example, if the light absorption layer is a layer that simultaneously shows absorption of ultraviolet and infrared rays, it can be designed to exhibit simultaneously an absorption band in a wavelength range of about 300 nm to 390 nm and an absorption band in a wavelength range of 600 nm to 800 nm.

The infrared absorption layer and the ultraviolet absorption layer may be composed of one layer or may be composed of separate layers. For example, one layer may be designed to exhibit both absorption maxima of the ultraviolet absorption layer and absorption maxima of the infrared absorption layer, or two layers may be formed to exhibit respective absorption maxima. In addition, a plurality of infrared absorption layers and/or ultraviolet absorption layers may be configured.

Each absorption layer may include only one type of absorbent. If necessary, it may include two or more types of absorbents to properly cut infrared rays and/or ultraviolet rays.

For example, the infrared absorption layer may include at least a first absorbent having an absorption maximum wavelength within a range of 700 nm to 720 nm and a full width at half maximum within a range of 50 nm to 60 nm; and a second absorbent having an absorption maximum wavelength within a range of 730 nm to 750 nm and a half width at half maximum within a range of 60 nm to 70 nm. The ultraviolet absorption layer may include at least an absorbent having an absorption maximum wavelength within a range of 340 nm to 390 nm. The infrared and ultraviolet absorption layer may be composed of one layer.

Materials and construction methods constituting the absorption layer are not particularly limited and known materials and construction methods can be applied. The absorption layer is formed using material in which an absorbent (such as a dye or pigment) capable of exhibiting a desired absorption maximum is blended with a transparent resin.

For example, as the ultraviolet absorbent, a known absorbent exhibiting an absorption maximum in a wavelength range of about 300 nm to 390 nm can be applied. Examples of the ultraviolet absorbent may include ABS 407 from Exiton; UV381A, UV381B, UV382A, UV386A, and VIS404A from QCR Solutions Corp.; ADA1225, ADA3209, ADA3216, ADA3217, ADA3218, ADA3230, ADA5205, ADA3217, ADA2055, ADA6798, ADA3102, ADA3204, ADA3210, ADA2041, ADA3201, ADA3202, ADA3215, ADA3219, ADA3225, ADA3232, ADA4160, ADA5278, ADA5762, ADA6826, ADA7226, ADA4634, ADA3213, ADA3227, ADA5922, ADA5950, ADA6752, ADA7130, ADA8212, ADA2984, ADA2999, ADA3220, ADA3228, ADA3235, ADA3240, ADA3211, ADA3221, ADA5220, and ADA7158 from HW Sands Corp.; and DLS 381B, DLS 381C, DLS 382A, DLS 386A, DLS 404A, DLS 405A, DLS 405C, and DLS 403A, etc. from CRYSTALYN Corp. but are not limited to.

Appropriate dyes or pigments that exhibit maximum absorption in the wavelength range of 600 nm to 800 nm may also be used as infrared absorbents. For example, squarylium-based dyes, cyanine-based compounds, phthalocyanine-based compounds, and naphthalocyanine-based compounds or dithiol metal complex compounds may be used but are not limited to.

Publicly known resins may also be used for the transparent resin applied to the absorption layer. For examples, at least one of more from cyclic olefin resins, polyarylate resins, polysulfone resins, polyether sulfone resins, polyparaphenylene resins, and polyarylene ether phosphine oxide resins, polyimide resins, polyetherimide resins, polyamideimide resins, acrylic resins, polycarbonate resins, polyethylene naphthalate resins, and various organic-inorganic hybrid resins may be used.

Such an absorption layer may also be formed to have a predetermined refractive index relationship with respect to the substrate. For example, the lower limit of the absolute value of the difference between the refractive index of the light absorption layer and the refractive index of the substrate may be 0.2%, 0.4%, 0.6%, 0.8%, 1%, 2%, 3%, 4%, 5% or 6%, and the upper limit may be about 10%, 9%, 8%, 7%, 6%, 5%, 4%, 3%, 2%, 1% or 0.7%. The absolute value may be greater than or greater than equal to any one of the lower limits described above, or less than or less than equal to any one of the upper limits described above, or within a range of greater than or greater than equal to any one of the lower limits and less than or less than equal to any one of the upper limits described above. The light absorption layer may have a higher refractive index or a lower refractive index than the substrate as long as the above refractive index relationship with respect to the substrate is shown.

The light absorption layer is usually formed to have a thickness within a range of about 1 m to about 20 m, but the thickness of the light absorption layer may not be limited to. The light absorption layer may include one layer or two or more layers in the optical filter, and if the light absorption layer includes two or more layers, absorption characteristics of each layer may be the same or different from each other.

The optical filter of the present invention may include a so-called dielectric multilayer film as an additional layer. Such a multilayer film may be formed on one side or both sides of the substrate, the transmittance control layer and/or the light absorption layer.

Such a dielectric multilayer film may usually have a multilayer structure including at least two sublayers having different refractive indices and may include a multilayer structure in which the two sublayers are repeatedly stacked. For example, the dielectric multilayer film may include a structure in which first and second sublayers having different refractive indices are repeatedly stacked. The first and second sub-layers are sub-layers distinguished by a difference in refractive index between them.

The dielectric multilayer film is a film formed by repeatedly stacking a dielectric material with a low refractive index and a dielectric material with a high refractive index and is used to form a so-called IR reflective layer and an anti-reflection (AR) layer In the present invention, a dielectric multilayer film may be applied for forming such a publicly known IR reflective layer or an AR layer

The type of material forming the dielectric multilayer film, in other words, the material forming each of the sub-layers, may not be particularly limited, and publicly known materials can be applied. In general, SiO₂ or fluorides such as Na₅Al₃F₁₄, Na₃AlF₆ or MgF₂ are used to manufacture the low refractive index sublayer, and TiO₂, Ta₂O₅, Nb₂O₅, ZnS or ZnSe, etc. may be used to manufacture the high refractive index sublayer but materials applied in the present invention are not limited to the above.

There is no particular limitation on the selection of the low refractive index and high refractive index sublayer materials, their arrangement or thickness, etc to form the dielectric multilayer film. For example, the type of designing for forming a publicly known IR reflective layer, an anti-reflection (AR) layer, and other dielectric multilayer film can be applied without limitation.

A method of forming the dielectric multilayer film is not particularly limited, and may be formed by applying, for example, a known deposition method. In the industry, a method for controlling the reflection or transmission characteristics of the dielectric multilayer film is known in consideration of the deposition thickness or number of layers of the sublayer, and in the present invention, a dielectric multilayer film exhibiting desired characteristics can be formed according to such a known method.

The optical filter may also include a pressure-sensitive adhesive layer, an adhesive layer, and/or a primer layer as additional layers. Such layers are usually applied to improve adhesion between layers in an optical filter. In the present invention, the pressure-sensitive adhesive layer, the adhesive layer, and/or the primer layer may be formed by using known materials.

In addition to the above-described layers, the optical filter may include various known layers according to purposes. Depending on the type and configuration of the layers included in the optical filter, the position of the transmittance control layer and the refractive index between the layers of the optical filter may be controlled within the range of the above-described refractive index relationship.

For example, when the pressure-sensitive adhesive layer, the adhesive layer, or the primer layer is included, the pressure-sensitive adhesive layer, the adhesive layer, or the primer layer may be included between the light absorption layer and the substrate. In this case, the location of the transmittance control layer is not particularly limited but may be present on a surface opposite to the surface on which the pressure-sensitive adhesive layer of the substrate is formed or on a surface opposite to the surface on which the pressure-sensitive adhesive layer of the light absorption layer is formed.

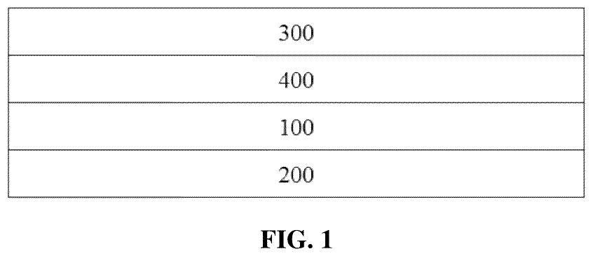

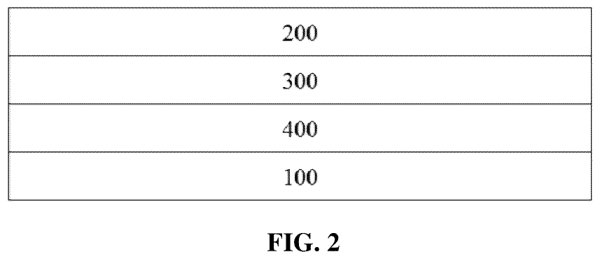

FIG. 1 is a cross-sectional view of an optical filter where the light absorption layer 300, the pressure-sensitive adhesive layer 400, the substrate 100, and the transmittance control layer 200 are sequentially stacked, and FIG. 2 is a cross-sectional view of an optical filter where the transmittance control layer 200, the light absorption layer 300, the pressure-sensitive adhesive layer 400, and the substrate 100 are sequentially stacked.

For the stacked structure as illustrated in FIGS. 1 and 2, the lower limit of the difference (100×(n₃₀₀−n₁₀₀)/n₁₀₀) of the refractive index of the light absorption layer (n₃₀₀) with respect to the refractive index of the substrate (n₁₀₀) may be about 0.2%, 0.4% or 0.6%, and the upper limit may be about 2%, 1.5%, 1%, 0.9%, 0.8% or 0.7%. The difference in refractive index may be greater than or greater than equal to any one of the lower limits described above, or less than or less than equal to any one of the upper limits described above, or within a range of greater than or greater than equal to the lower limits described above and less than or less than equal to any one of the upper limits described above.

For the stacked structure as illustrated in FIGS. 1 and 2, the lower limit of the difference (100×(n₄₀₀−n₁₀₀)/n₁₀₀) of the refractive index of the pressure-sensitive adhesive layer (n₄₀₀) with respect to the refractive index of the substrate (n₁₀₀) may be about 3%, 4% or 5%, and the upper limit may be about 10%, 8% or 6%. The difference in refractive index may be greater than or greater than equal to any one of the lower limits described above, or less than or less than equal to any one of the upper limits described above, or within a range of greater than or greater than equal to any one of the lower limits described above and less than or less than equal to any one of the upper limits described above.

For the stacked structure as illustrated in FIGS. 1 and 2, the lower limit of the difference (100×(n₄₀₀−n₂₀₀)/n₂₀₀) of the refractive index of the pressure-sensitive adhesive layer (n₄₀₀) with respect to the refractive index of the transmittance control layer (n₂₀₀) may be about 8%, 9%, or 10%, and the upper limit may be about 15%, 13%, or 11%. The difference in refractive index may be greater than or greater than equal to any one of the lower limits described above, or less than or less than equal to any one of the upper limits described above, or within a range of greater than or greater than equal to any one of the lower limits described above and less than or less than equal to any one of the upper limits described above.

In addition, for the stacked structure as shown in FIGS. 1 and 2, the lower limit of the difference (100×(n₂₀₀−n₁₀₀)/n₁₀₀) of the refractive index of the transmittance control layer (n₂₀₀) with respect to the refractive index of the substrate (n₁₀₀) may be about −10%, −8%, −6% or −5%, and the upper limit may be about −2% or −4%. The difference in refractive index may be greater than or greater than equal to any one of the lower limits described above, or less than or less than equal to any one of the upper limits described above, or within a range of greater than or greater than equal to any one of the lower limits described above and less than or less than equal to any one of the upper limits described above.

In the case of having the above-described refractive index relationship for the stacked structure as shown in FIGS. 1 and 2, an optical filter securing a desired transmittance may be obtained. Although not particularly limited, for the above structure, the light absorption layer and the pressure-sensitive adhesive layer are in direct contact with each other, the pressure-sensitive adhesive layer and the substrate are in direct contact with each other, and the transmittance control layer may be in direct contact with the light absorption layer or the substrate.

In some cases, the optical filter may include two or more light absorption layers. For example, the optical filter may include first and second light absorption layers having different refractive indices each other.

In this case, a light absorption layer having a lower refractive index may be present closer to the substrate than other light absorption layers. For example, if the first light absorption layer has a lower refractive index than the second light absorption layer between the first and second light absorption layers, the first light absorption layer may exist between the second light absorption layer and the transparent substrate.

In this case, the transmittance control layer may be positioned such that the second light absorption layer exists between the transmittance control layer and the first light absorption layer.

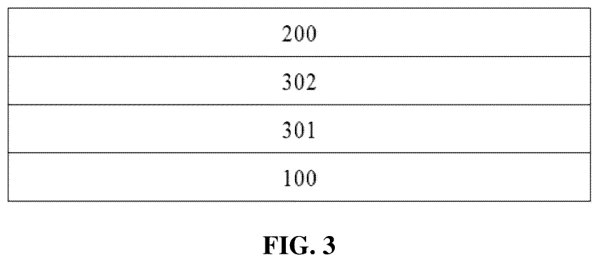

FIG. 3 shows this structure and shows a case where the transmittance control layer 200, the second light absorption layer 302, the first light absorption layer 301 and the substrate 100 are sequentially formed.

In the case of the structure shown in FIG. 3, the lower limit of the difference (100×(n₃₀₁−n₁₀₀)/n₁₀₀) of the refractive index (n₃₀₁) of the first light absorption layer 301 with respect to the refractive index of the substrate 100 (n₁₀₀) may be about −10%, −8%, −6% or −5%, and the upper limit may be about −2%, −4% or −4.5%. The difference in refractive index may be greater than or greater than equal to any one of the lower limits described above, or less than or less than equal to any one of the upper limits described above, or within a range of greater than or equal to equal to any one of the lower limits described above and less than or less than equal to any one of the upper limits described above.

In the case of the structure shown in FIG. 3, the lower limit of the difference (100×(n₃₀₂−n₁₀₀)/n₁₀₀) of the refractive index (n₃₀₂) of the first light absorption layer 302 with respect to the refractive index of the substrate 100 (n₁₀₀) may be about 2%, 4%, or 6%, and the upper limit may be about 10%, 9%, 8%, or 7%. The difference in refractive index may be greater than or greater than equal to any one of the lower limits described above, or less than or less than equal to any one of the upper limits described above, or within a range of greater than or equal to equal to any one of the lower limits described above and less than or less than equal to any one of the upper limits described above.

In the above structure, the transmittance control layer 200 may be present on the surface opposite to the surface where the first light absorption layer 301 of the substrate 100 is formed. Or, as shown in FIG. 3, the transmittance control layer 200 may be present on the surface opposite to the surface where the first light absorption layer 301 of the second light absorption layer 302 is formed.

In this case, the lower limit of the difference (100×(n₂₀₀−n₁₀₀)/n₁₀₀) of the refractive index of the transmittance control layer (n₂₀₀) with respect to the refractive index of the substrate (n₁₀₀) may be about −10%, −8%, −6% or −5% and the upper limit may be about −2% or −4%. The difference in refractive index may be greater than or greater than equal to any one of the lower limits described above, or less than or less than equal to any one of the upper limits described above, or within a range of greater than or equal to equal to any one of the lower limits described above and less than or less than equal to any one of the upper limits described above.

In the case of having the above-described refractive index relationship for the structure including two types of light absorption layers as shown in FIG. 3, an optical filter securing a desired transmittance may be obtained. As described above, a method of controlling the refractive index relationship of the light absorption layer, the substrate, the transmittance control layer, and the pressure-sensitive adhesive layer is not particularly limited. For example, it is possible to satisfy the refractive index by selecting an appropriate material according to the purpose from materials known in public to be capable of forming the light absorption layer, the substrate, the transmittance control layer, the pressure-sensitive adhesive layer. If necessary, the refractive index can be adjusted by applying low refractive particles (e.g., hollow particles) that can ensure low refraction and/or high refractive particles (TiO₂, etc.) that can ensure high refraction.

Although not particularly limited, in the above structure, the second light absorption layer and the first light absorption layer may be in direct contact with each other, the first light absorption layer and the substrate may be in direct contact with each other, and the transmittance control layer may be in direct contact with the second light absorption layer or the substrate.

The optical filter may include a first layer, a second layer, a third layer, and a fourth layer that are sequentially stacked. In the structure, any one of the first to fourth layers may be the above-described substrate, and any one of the first to fourth layers may be the transmittance control layer. Further, among the first to fourth layers in the above structure, a layer other than the substrate and the transmittance control layer may be the above-described light absorption layer, pressure-sensitive adhesive layer, adhesive layer, and/or primer layer.

The above structure may be a stacked structure as illustrated in FIG. 1 or 2. Therefore, for one example, in the above structure, the first layer or the second layer may be the above-described light absorption layer; the second or third layer may be the above-described pressure-sensitive adhesive layer; the third or fourth layer may be the substrate; and the first layer or the fourth layer may be the transmittance control layer. Details of the light absorption layer, the substrate, the transmittance control layer, and the pressure-sensitive adhesive layer are as described above.

In the above structure, the relationship between the refractive indices of each layer can be controlled. For example, referring that the refractive index of the first layer is n₁, the refractive index of the second layer is n₂, the refractive index of the third layer is n₃, and the refractive index of the fourth layer is n₄, the refractive indices n₁ to n₄ may satisfy the relationship of Equation 4 or 5 below.

$${n}_{2} > {n}_{1} \geq {n}_{3} > {n}_{4} \qquad [ Equation 4 ]$$

$${n}_{2} > {n}_{3} \geq {n}_{1} > {n}_{4} \qquad [ Equation 5 ]$$

For the above structure, the lower limit of the average refractive index (arithmetic mean of n₁, n₂, n₃ and n₄) of the first to fourth layers may be about 1.3, 1.4 or 1.5, and the upper limit may be about 1.9, 1.8, 1.7 or 1.6. The average refractive index may be greater than or greater than equal to any one of the lower limits described above, or less than or less than equal to any one of the upper limits described above, or within a range of greater than or equal to equal to any one of the lower limits described above and less than or less than equal to any one of the upper limits described above.

In this case, the lower limit of the absolute value difference between the average refractive indices of the first and third layers (arithmetic mean of n₁ and n₃) and the average refractive indices of the second and fourth layers (arithmetic mean of n₂ and n₄) may be about 0, 0.1, 0.2, 0.3, 0.4 or 0.5, and the upper limit may be about 2, 1.5, 1, 0.5, 0.4, 0.3, 0.2 or 0.1. The difference may be greater than or greater than equal to any one of the lower limits described above, or less than or less than equal to any one of the upper limits described above, or within a range of greater than or equal to equal to any one of the lower limits described above and less than or less than equal to any one of the upper limits described above. By selecting and arranging the layers to satisfy these relationships, an optical filter having desired characteristics can be obtained.

In another example, the optical filter including the first to fourth layers may satisfy the relationship of Equation 6 or 7 below. In the structure, any one of the first to fourth layers may be the above-described substrate, and any one of the first to fourth layers may be the transmittance control layer. Further, among the first to fourth layers in the above structure, a layer other than the substrate and the transmittance control layer may be the above-described light absorption layer, pressure-sensitive adhesive layer, adhesive layer, and/or primer layer.

An optical filter that satisfies Equation 6 or 7 may be the optical filter illustrated in FIG. 3. Accordingly, in the above case, the first layer may be the transmittance control layer, the second and third layers may be the light absorption layer, and the fourth layer may be the substrate.

$${n}_{v} - {n}_{1} > 0 , \qquad [ Equation 6 ]$$

$${n}_{v} - {n}_{2} < 0 ,$$

$${n}_{v} - {n}_{3} > 0$$

$$and$$

$${n}_{v} - {n}_{4} < 0$$

$${n}_{v} - {n}_{1} < 0 , \qquad [ Equation 7 ]$$

$${n}_{v} - {n}_{2} > 0 ,$$

$${n}_{v} - {n}_{3} < 0$$

$$and$$

$${n}_{v} - {n}_{4} > 0$$

In Equations 6 and 7, n₁, n₂, n₃ and n₄ are the refractive indices of the first layer, the second layer, the third layer and the fourth layer, respectively, and nᵥ may be arithmetic average of the n₁, n₂, and n₃ and n₄.

The lower limit of nᵥ may be about 1.3, 1.4, or 1.5, and the upper limit may be about 1.9, 1.8, 1.7, or 1.6. The average refractive index may be greater than or greater than equal to any one of the lower limits described above, or less than or less than equal to any one of the upper limits described above, or within a range of greater than or equal to equal to any one of the lower limits described above and less than or less than equal to any one of the upper limits described above.

In addition, the lower limit of each range of nᵥ−n₁, nᵥ−n₂, nᵥ−n₃ and nᵥ−n₄ may be about 0, 0.01, 0.02, 0.03 0.04, or 0.05 in the case of a positive number. The upper limit may be about 1, 0.5, 0.1, 0.09, 0.08, 0.07 or 0.065. The range may be greater than or greater than equal to any one of the lower limits described above, or less than or less than equal to any one of the upper limits described above, or within a range of greater than or equal to equal to any one of the lower limits described above and less than or less than equal to any one of the upper limits described above.

In addition, the lower limit of each range of nᵥ−n₁, nᵥ−n₂, nᵥ−n₃ and nᵥ−n₄ may be about −1, −0.5, −0.1, −0.05, or −0.03 in the case of a negative number. The upper limit may be about 0, −0.5, −0.3, −0.1, −0.05, or −0.03. The range may be greater than or greater than equal to any one of the lower limits described above, or less than or less than equal to any one of the upper limits described above, or within a range of greater than or equal to equal to any one of the lower limits described above and less than or less than equal to any one of the upper limits described above. By selecting and arranging the layers to satisfy these relationships, an optical filter having desired characteristics can be obtained.

The optical filter of the present invention can exhibit excellent optical properties. For example, the optical filter may exhibit a transmission band having a T50% cut-on wavelength within a range of about 380 nm to 425 nm. The T50% cut-on wavelength is the shortest wavelength among wavelengths exhibiting a transmittance of 50% within a wavelength range of 350 nm to 425 nm. One or two or more wavelengths exhibiting the transmittance of 50% may be present within the range of 380 nm to 425 nm. If one exists, it is the wavelength, and if two or more exist, the shortest wavelength among them is the T50% cut-on wavelength. The T50% cut-on wavelength may be further adjusted within the range of 385 nm or more, 390 nm or more, 395 nm or more, 400 nm or more, 405 nm or more, or 410 nm or more and/or 420 nm or less, 415 nm or less, 410 nm or less, 405 nm or less, or 400 nm or less.

The optical filter may exhibit a transmission band having a T50% cut-off wavelength within a range of about 590 nm to about 680 nm. The T50% cut-off wavelength is the longest wavelength among wavelengths exhibiting a transmittance of 50% within a wavelength range of 560 nm to 700 nm. One or two or more wavelengths exhibiting transmittance of 50% may be present within the range of 560 nm to 700 nm. If one exists, it is the longest wavelength, and if two or more exist, the longest wavelength among them is the T50% cut-off wavelength. The T50% cut-off wavelength may be further adjusted within the range of 600 nm or more, 610 nm or more, 620 nm or more, 630 nm or more, or 640 nm or more, and/or 670 nm or less, 660 nm or less, 650 nm or less, or 640 nm or less.

The lower limit of the average transmittance in the range of 425 nm to 465 nm of the optical filter may be about 70% or 75%, and the upper limit may be about 100%, 95%, 90%, 85%, or 80%. The transmittance may be greater than or greater than equal to any one of the lower limits described above, or less than or less than equal to any one of the upper limits described above, or within a range of greater than or equal to equal to any one of the lower limits described above and less than or less than equal to any one of the upper limits described above.

The lower limit of the average transmittance in the range of 466 nm to 480 nm of the optical filter may be about 70%, 75%, 80%, or 85%, and the upper limit may be about 100%, 95%, or 90%. The transmittance may be greater than or greater than equal to any one of the lower limits described above, or less than or less than equal to any one of the upper limits described above, or within a range of greater than or equal to equal to any one of the lower limits described above and less than or less than equal to any one of the upper limits described above.

The lower limit of the average transmittance in the range of 481 nm to 560 nm of the optical filter may be about 70%, 75%, 80%, 85%, or 90%, and the upper limit may be 100%, 95%, or 90%. The transmittance may be greater than or greater than equal to any one of the lower limits described above, or less than or less than equal to any one of the upper limits described above, or within a range of greater than or equal to equal to any one of the lower limits described above and less than or less than equal to any one of the upper limits described above.

The lower limit of the average transmittance in the range of 850 nm to 1,050 nm of the optical filter may be about 0%, 5%, 15%, 20%, or 25%, and the upper limit may be about 30%, 25%, or 20%. %, 15%, 10%, 5% or 1%. The transmittance may be greater than or greater than equal to any one of the lower limits described above, or less than or less than equal to any one of the upper limits described above, or within a range of greater than or equal to equal to any one of the lower limits described above and less than or less than equal to any one of the upper limits described above.

The lower limit of transmittance at 950 nm of the optical filter may be about 0%, 5%, 15%, 20%, or 25%, and the upper limit may be about 30%, 25%, 20%, 15%, 10%, 5%, 1% or 0.5%. The transmittance may be greater than or greater than equal to any one of the lower limits described above, or less than or less than equal to any one of the upper limits described above, or within a range of greater than or equal to equal to any one of the lower limits described above and less than or less than equal to any one of the upper limits described above.

The lower limit of transmittance at 1,050 nm of the optical filter may be about 0%, 5%, or 15%, and the upper limit may be about 20%, 15%, 10%, 5%, 1%, or 0.5%. The transmittance may be greater than or greater than equal to any one of the lower limits described above, or less than or less than equal to any one of the upper limits described above, or within a range of greater than or equal to equal to any one of the lower limits described above and less than or less than equal to any one of the upper limits described above. The optical filter of the present invention may exhibit any one or a combination of two or more of the above optical characteristics and may suitably satisfy all of the above-described optical characteristics.

The optical filter of the present invention may exhibit any one or a combination of two or more of the above optical properties, and may suitably satisfy all of the above-described optical properties.

This invention also relates to an image capturing device including the optical filter. At this time, a configuration method of the image capturing device, or an application method of the optical filter may not be particularly limited, and publicly known configurations and application methods may be applied.

In addition, the use of the optical filter of the present invention may not be limited to the image capturing device. It also can be applied to various other applications requiring near-infrared ray cut filter (e.g., display devices such as PDPs, etc.).

The optical filter of the present invention will be specifically described through the following examples. However, the scope of the optical filter of the present invention is not limited by the following examples.

### 1. Transmittance Evaluation

Transmittance was measured using a spectrophotometer (manufactured by Perkin-Elmer, Product Name: Lambda750 spectrophotometer) for specimens obtained by cutting the measuring object to be 10 mm and 10 mm in width and length, respectively. Transmittance was measured for each wavelength and incident angle according to the manual of the equipment. The specimen was placed on a straight line between the measuring beam and the detector of the spectrophotometer, and transmittance was measured while changing the incident angle of the measuring beam from 0° to 40°. Unless specifically stated otherwise, the result of the transmittance referred to in this embodiment is the result when the incident angle is 0°. The angle of incidence of 0° is a direction substantially parallel to the direction normal to the surface of the specimen.

The average transmittance or average reflectance within a predetermined wavelength range in transmittance is the result of measuring the transmittance for each wavelength while increasing the wavelength by 1 nm from the shortest wavelength within the wavelength range, and then calculating the arithmetic mean of the measured transmittance. The minimum transmittance is the minimum transmittance among the transmittances measured while increasing the wavelength by 1 nm. For example, the average transmittance within the wavelength range of 350 nm to 360 nm is the arithmetic mean of transmittances measured at wavelengths of 350 nm, 351 nm, 352 nm, 353 nm, 354 nm, 355 nm, 356 nm, 357 nm, 358 nm, 359 nm and 360 nm, and the minimum transmittance within the wavelength range of 350 nm to 360 nm is the lowest transmittance among transmittances measured at wavelengths of 350 nm, 351 nm, 352 nm, 353 nm, 354 nm, 355 nm, 356 nm, 357 nm, 358 nm, 359 nm and 360 nm.

### 2. Copper Content Evaluation

The copper content of the glass substrate was confirmed using X-ray fluorescence spectrometry (WD XRF, Wavelength Dispersive X-Ray Fluorescence Spectrometry). When X-rays are irradiated on a specimen (glass substrate) using the equipment, characteristic secondary X-rays are generated from individual elements of the specimen, and the equipment detects the secondary X-rays according to the wavelength of each element. The intensity of the secondary X-rays is proportional to the element content, and therefore, quantitative analysis can be performed through the intensity of the secondary X-rays measured according to the wavelength of each element.

### 3. Evaluation of Refractive Index

The refractive index was measured for a wavelength of 520 nm using an ATAGO measuring instrument (ATAGO, NAR-4T).

### Preparation Example 1: Preparation of Absorption Layer Material (A)

The absorption layer material (A) was prepared by dispersing a pigment and a binder resin (polyacrylate-based, Sumitomo, Inc., Sumipex) in a solvent (methyl ethyl ketone (MEK)). In the above process, the mixing ratio of the binder resin, the pigment and the solvent was about 1.54:0.2:8.44 in terms of weight ratio (binder resin:pigment:solvent).

For the dye, dye (1) (IRA 1032, Exciton, diimmonium-based compound, maximum absorption wavelength range: 900 nm to 1,200 nm), dye (2) (IRA 705, Exciton, squarylium-based compound, maximum absorption wavelength range: 700 nm to 800 nm) and a mixture of dye (3) (ADA3232, HW. SANDS, absorption maximum wavelength range: 300 nm to 400 nm) was used. The mixture of the pigments includes the three pigments in a weight ratio of 3.8:3.3 2.9 (dye (1):dye (2):dye (3)).

The absorption layer material (A) may be coated in an appropriate manner and subjected to heat treatment (at about 135° C. for about 2 hours) to form an absorption layer.

For example, the refractive index of the absorption layer formed using the absorption layer material (A) can be evaluated by a method as stated described above after forming the absorption layer with a thickness of about 3.5 m by coating the absorption layer material (A) on a substrate (glass substrate) with a spin coater and curing at 135° C. for about 2 hours. The refractive index evaluated in this way was about 1.53.

### Preparation Example 2: Preparation of Absorption Layer Material (B)

The absorption layer material (B) may be prepared by dispersing the dye (1) of Preparation Example 1 and the binder resin in a solvent (methyl ethyl ketone (MEK)). In the above process, as the binder resin, a siloxane oligomer (partial hydrolysis condensate of 3-glycidoxypropyltrimethoxysilane) was used. In the above process, the mixing ratio of the absorbent, the binder resin, and the solvent was about 1:75:24 in weight ratio (dye:binder resin:solvent).

An absorption layer may be formed by coating the absorption layer material (B) and heat-treating (at about 140° C. for about 2 hours). For example, the refractive index of the absorption layer was evaluated for the absorption layer after forming the absorption layer having a thickness of about 5 m by coating the absorption layer material (B) on a glass substrate with a spin coater and maintaining at 140° C. for 2 hours. The refractive index evaluated in this way is about 1.45.

### Preparation Example 3: Preparation of Absorbent Layer Material (C)

The absorption layer material (C) was prepared by dispersing a pigment and a binder resin (Polyimide) in a solvent (gamma butyrolactone (GBL)). The mixing ratio of the pigment, binder resin, and solvent was about 0.1:70:29.9 in weight ratio (dye:binder resin:solvent). Meanwhile, for the pigment, a mixture obtained by mixing the pigment (2) and the pigment (3) of Preparation Example 1 in a weight ratio of 4.9:5.1 (dye (2):dye (3)) was used.

The absorption layer material (C) may be coated in an appropriate manner and heat treated (at about 140° C. for about 2 hours) to form an absorption layer.

The absorber layer material (C) was coated on a glass substrate with a spin coater, maintained at 140° C. for 2 hours to form the absorption layer having a thickness of about 6 m, and then, the refractive index of the absorption layer was evaluated. The refractive index evaluated in this way is about 1.62.

### Embodiment 1

A resin layer (transmittance control layer) was prepared on both sides of a glass substrate (thickness: about 0.21 mm) having a refractive index of about 1.52. The resin layer (transmittance control layer) was prepared by using coating solution in which a solvent (dibutyl ether) and inorganic polysilazane (manufacturer: Sanwa Chemical, Product Name: 1035) were mixed in a weight ratio of 9.5:0.5 (solvent:inorganic polysilazane). The coating solution was spin-coated on the glass substrate and maintained at 140° C. for 2 hours to form the resin layer (transmittance control layer) having a thickness of about 20 nm. The refractive index of the resin layer (transmittance control layer) was about 1.45.

A resin layer (transmittance control layer) as described above was formed on both sides of the glass substrate.

### Embodiment 2

As a glass substrate, the same glass substrate as in Embodiment 1 was applied, and a resin layer (transmittance control layer) was prepared on one surface of the glass substrate. The resin layer (transmittance control layer) was prepared by using a coating solution of a mixture of a solvent (dibutyl ether) and organic polysilazane (manufacturer: Sanwa Chemical, Product Name: 1001-5) in a weight ratio of 9.5:0.5 (solvent:organic polysilazane). The coating solution was spin-coated on the glass substrate and maintained at 140° C. for about 2 hours to form the resin layer (transmittance control layer) having a thickness of about 76 nm. The refractive index of the resin layer (transmittance control layer) was about 1.45.

### Embodiment 3

A resin layer (transmittance control layer) was prepared on both sides of a glass substrate using the coating solution of Embodiment 2. At this time, the method of preparing the resin layer is the same as in Embodiment 2, and the same glass substrate as in Embodiment 2 was used as the glass substrate.

The evaluation results for Embodiments 1 to 3 were summarized and described in Table 1 below. In Table 1, Tₘᵢₙ is the minimum transmittance (unit: %) in the corresponding wavelength region, and Tₐᵥₑ is the average transmittance (unit: %) in the corresponding wavelength region. In Table 1, the refractive index is the refractive index of the resin layer (transmittance control layer) formed in each Embodiment and Ref is the transmittance of the glass substrate itself used in Embodiments 1 to 3.

TABLE 1

| | | | Embodiment | | |
|---|---|---|---|---|---|
| | | Ref | 1 | 2 | 3 |
| Refractive Index | | 1.52 | 1.45 | 1.45 | 1.45 |
| 425 nm to 465 | Tₘᵢₙ | 91.8 | 92.7 | 93.4 | 94.5 |
| nm | Tₐᵥₑ | 91.8 | 92.8 | 93.5 | 94.7 |
| 466 nm to 480 | Tₘᵢₙ | 91.8 | 92.7 | 93.5 | 94.7 |
| nm | Tₐᵥₑ | 91.9 | 92.7 | 93.5 | 94.7 |
| 481 nm to 560 | Tₐᵥₑ | 91.9 | 92.7 | 93.5 | 94.7 |
| nm | | | | | |

From the results of Table 1, the rate of increase/decrease (unit: %) of the transmittance (Tₘᵢₙ, Tₐᵥₑ) of each Embodiment was confirmed and summarized in Table 2. The increase/decrease rate was calculated by the formula 100×(T2−T1)/T1 when each transmittance (Ref) of the glass substrate was T1 and each transmittance of the glass substrate where the resin layer (transmittance control layer) was formed was T2. As shown in the results of Tables 1 and 2, it can be seen that a high transmittance compared to the transmittance of the glass substrate itself is obtained by the resin layer (transmittance control layer) in Embodiments 1 to 3.

TABLE 2

| | | Embodiment | | |
|---|---|---|---|---|
| | | 1 | 2 | 3 |
| 425 nm to 465 nm | Tₘᵢₙ | 1 | 1.7 | 2.9 |
| | Tₐᵥₑ | 1.1 | 1.9 | 3.2 |
| 466 nm to 480 nm | Tₘᵢₙ | 1 | 1.9 | 3.2 |
| | Tₐᵥₑ | 0.9 | 1.7 | 3 |
| 481 nm to 560 nm | Tₐᵥₑ | 0.9 | 1.7 | 3 |

Through the results in Tables 1 and 2, it can be seen that in Examples 1 to 3, the resin layer (transmittance control layer) ensures a higher transmittance compared to the transmittance of the glass substrate itself.

### Embodiment 4

As a transparent substrate, a phosphate-based infrared absorbing glass substrate (manufactured by HOYA, thickness: about 0.21 mm) having infrared absorption characteristics was used. The copper content measured for the infrared absorbing glass substrate was about 2.89 wt %. A resin layer (transmittance control layer) was prepared on one surface of the glass substrate by using the same coating solution as that used in Embodiment 2. At this time, the resin layer was prepared in the same way as in Embodiment 2, and the thickness was also adjusted in the same way.

### Embodiment 5

A resin layer (transmittance control layer) was prepared in the same manner as in Embodiment 3 on both sides of the same transparent substrate as used in Embodiment 4.

The evaluation results for Embodiments 4 and 5 were summarized and described in Table 3. In Table 3, Tₘᵢₙ is the minimum transmittance (unit: %) in the corresponding wavelength region, and Tₐᵥₑ is the average transmittance (unit: %) in the corresponding wavelength region. In Table, Ref is the transmittance of the glass substrate itself used in Embodiments 7 and 8. In Table 3, the rate of increase/decrease is a result calculated by the formula 100×(T2−T1)/T1 when each transmittance (Ref) of the glass substrate is T1 and each transmittance of the glass substrate where the resin layer is formed is T2, and its unit is %.

TABLE 3

| | | | Embodiment | | | |
|---|---|---|---|---|---|---|
| | | | 4 | | 5 | |
| | | | | Rate of | | Rate of |
| | | | Transmit- | Increase/ | Transmit- | Increase/ |
| | | Ref | tance | Decrease | tance | Decrease |
| 425 nm to | Tₘᵢₙ | 86.1 | 87.4 | 1.5 | 88.7 | 3 |
| 465 nm | Tₐᵥₑ | 87.3 | 88.6 | 1.5 | 90.1 | 3.3 |
| 466 nm to | Tₘᵢₙ | 88.3 | 89.6 | 1.5 | 91.1 | 3.2 |
| 480 nm | Tₐᵥₑ | 88.6 | 89.9 | 1.5 | 91.3 | 3 |
| 481 nm to | Tₐᵥₑ | 88.9 | 90 | 1.2 | 91.2 | 2.6 |
| 560 nm | | | | | | |

### Embodiment 6

As a glass substrate, a phosphate-based infrared absorbing glass substrate (manufactured by HOYA, thickness: about 0.21 mm, refractive index: about 1.57, copper content: 9.5% by weight) having infrared absorption characteristics was used. A resin layer (transmittance control layer) was prepared by using the same coating solution as that used in Embodiment 2. The refractive index of the resin layer formed of the coating solution, which is the material of the resin layer, was also evaluated in the same manner as in Embodiment 2, and as a result, the refractive index of the resin layer was about 1.45. The coating solution was coated on one surface of the glass substrate by spin coating and maintained at 140° C. for about 2 hours to prepared the resin layer having a thickness of about 76 nm.

### Embodiment 7

A resin layer was prepared in the same manner as in Embodiment 6, except that the maintaining temperature of the coating solution was 90° C. after spin coating and the resin layer was formed to have a thickness of about 70 nm.

The evaluation results for Embodiments 6 and 7 were summarized and described in Table 4. In Table 4, Tₘᵢₙ is the minimum transmittance (unit: %) in the corresponding wavelength region, and Tₐᵥₑ is the average transmittance (unit: %) in the corresponding wavelength region. In Table 4, Ref is the transmittance of the glass substrate itself used in Embodiments 9 and 10. In Table 4, the rate of increase/decrease is the result calculated by the formula 100×(T2−T1)/T1 when each transmittance (Ref) of the glass substrate is T1 and each transmittance of the glass substrate where the resin layer is formed is T2, and its unit is %.

TABLE 4

| | | | Embodiment | | | |
|---|---|---|---|---|---|---|
| | | | 6 | | 7 | |
| | | | | Rate of | | Rate of |
| | | | Transmit- | Increase/ | Transmit- | Increase/ |
| | | Ref | tance | Decrease | tance | Decrease |
| 425 nm to | Tₘᵢₙ | 91.1 | 92.5 | 1.5 | 91.5 | 0.4 |
| 465 nm | Tₐᵥₑ | 91.6 | 92.7 | 1.2 | 92.1 | 0.5 |
| 466 nm to | Tₘᵢₙ | 91.4 | 92.7 | 1.4 | 92.2 | 0.9 |
| 480 nm | Tₐᵥₑ | 91.6 | 92.9 | 1.4 | 92.4 | 0.9 |
| 481 nm to | Tₐᵥₑ | 91.7 | 93 | 1.4 | 92.6 | 1 |
| 560 nm | | | | | | |

From the results of Table 4, although the resin layer (transmittance control layer) in Embodiments 6 and 7 was prepared with the same type of material, Embodiment 6 having a curing temperature of 140° C. showed an excellent effect over Embodiment 7 having a curing temperature of 90° C. It is believed that this result is due to the difference in the degree of curing of the resin layer caused by the difference in the curing temperature, and consequently, a layer having a different refractive index was formed in Embodiment 7 over Embodiment 6.

### Embodiment 8

As a glass substrate, the same glass substrate as in Embodiment 2 was applied, and a resin layer (transmittance control layer) was prepared on one surface of the glass substrate. At this time, the resin layer was prepared by using the coating solution used in Embodiment 2. The preparation method and thickness of the resin layer were the same as in Embodiment 2.

Subsequently, an optical filter was manufactured by sequentially forming a pressure-sensitive adhesive layer and an absorption layer on the surface of the glass substrate where the resin layer (transmittance control layer) was not formed. The adhesive layer was formed to have a thickness of about 170 nm by using a known acrylic adhesive. The refractive index of this pressure-sensitive adhesive layer was about 1.60. The pressure-sensitive adhesive forming the pressure-sensitive adhesive layer was spin-coated on a glass substrate and maintained at 140° C. for about 30 minutes to form the pressure-sensitive adhesive layer. Subsequently, the absorption layer material (A) of Preparation Example 1 was spin-coated on the pressure-sensitive adhesive layer and maintained at 135° C. for about 2 hours to form an absorption layer having a thickness of about 3.5 m.

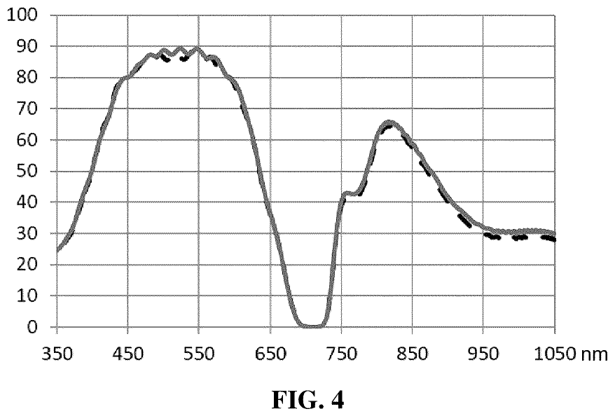

FIG. 4 is a spectrum showing transmittance characteristics of the optical filter (x-axis: Wavelength (nm) and y-axis: Transmittance (%)). In the spectrum, the dotted line indicates the result of the optical filter before a resin layer (high transmittance layer) is formed, and the solid line indicates the result of the optical filter of Embodiment 8.

Table 5 is an evaluation result of the optical filter. In Table 5, Tₘᵢₙ is the minimum transmittance (unit: %) in the corresponding wavelength region, and Tₐᵥₑ is the average transmittance (unit: %) in the corresponding wavelength region. In Table 5 below, Ref is a value for an optical filter (i.e., a filter having a structure of an absorption layer/pressure-sensitive adhesive layer/glass substrate) in which a resin layer (transmittance control layer) is not formed. In Table 5, T50% cut-on is the shortest wavelength (unit: nm) showing transmittance of 50% within the wavelength range of 350 nm to 425 nm, T50% cut-off is the longest wavelength (unit: nm) showing a transmittance of 50% within the wavelength range of 600 nm to 900 nm, and T10% cut-off is the longest wavelength (unit: nm) showing a transmittance of 10% within the wavelength range of 600 nm to 900 nm.

TABLE 5

| | | | Embodiment 8 | |
|---|---|---|---|---|
| | | | | Rate of |
| | | | Transmittance | Increase/ |
| | | | or | Decrease |
| | | Ref | Wavelength | (%) |
| T50% cut-on (nm) | | 398.6 | 398.7 | — |
| 425 nm to 465 nm | Tₘᵢₙ (%) | 68.2 | 68.4 | 0.3 |
| | Tₐᵥₑ (%) | 78.0 | 78.3 | 0.4 |
| 466 nm to 480 nm | Tₘᵢₙ (%) | 83.5 | 84.4 | 1.1 |
| | Tₐᵥₑ (%) | 84.7 | 85.5 | 1 |
| 481 nm to 560 nm | Tₐᵥₑ (%) | 86.3 | 87.4 | 0.0 |
| T50% cut-off (nm) | | 635.6 | 635.8 | — |
| T10% cut-off (nm) | | 678.2 | 679.1 | — |
| 950 nm | Transmittance | 29.7 | 30.9 | 4 |
| | (%) | | | |
| 1,050 nm | Transmittance | 29.0 | 27.8 | −4.1 |
| | (%) | | | |

### Embodiment 9

As a glass substrate, the same glass substrate as in Embodiment 2 was applied. An optical filter was prepared by sequentially forming a first absorption layer using the material of Preparation Example 2, a second absorption layer using the material of Preparation Example 3, and a resin layer (transmittance control layer) on one surface of the glass substrate (i.e., a structure of glass substrate/first absorption layer/second absorption layer/resin layer).

The first absorption layer was formed by spin-coating the absorption layer material of Preparation Example 2 on the glass substrate and maintained at 140° C. for about 2 hours to have a thickness of about 5 m. The second absorption layer was formed by spin-coating the absorption layer material of Preparation Example 3 on the first absorption layer and maintained at 140° C. for about 2 hours to form a thickness of about 6 m. Subsequently, the resin layer (transmittance control layer) having the same thickness was formed on the second absorption layer in the same manner as in Embodiment 2.

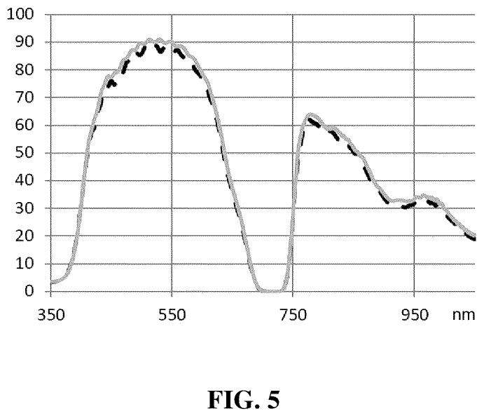

FIG. 5 is a spectrum showing transmittance characteristics of the manufactured optical filter (x-axis: wavelength (nm) and y-axis: Transmittance (%)). In the spectrum, the dotted line indicates the result of the optical filter before the resin layer (transmittance control layer) is formed, and the solid line indicates the result of the optical filter of Embodiment 9.

Table 6 shows the evaluation results of the optical filter, and in Table 6, Tₘᵢₙ is the minimum transmittance (unit: %) in the corresponding wavelength region, and Tₐᵥₑ is the average transmittance (unit: %) in the corresponding wavelength region. Also, in Table 6, Ref is a value for an optical filter (i.e., a filter having a structure of second absorption layer/first absorption layer/glass substrate) where the resin layer (transmittance control layer) is not formed.

In Table 6, T50% cut-on is the shortest wavelength (unit: nm) showing a transmittance of 50% within a wavelength range of 350 nm to 425 nm, and T50% cut-off is the longest wavelength (unit: nm) showing a transmittance of 50% within a wavelength range of 600 nm to 900 nm. T10% cut-off is the longest wavelength (unit: nm) showing 10% transmittance within the wavelength range of 600 nm to 900 nm.

TABLE 6

| | | | Embodiment 9 | |
|---|---|---|---|---|
| | | | | Rate of |
| | | | Transmittance | Increase/ |
| | | | or | Decrease |
| | | Ref | Wavelength | (%) |
| T50% cut-on (nm) | | 411.2 | 410.9 | — |
| 425 nm to 465 nm | Tₘᵢₙ (%) | 63.9 | 65.9 | 3.1 |
| | Tₐᵥₑ (%) | 74.9 | 76.8 | 2.5 |
| 466 nm to 480 nm | Tₘᵢₙ (%) | 80.9 | 82.6 | 2.4 |
| | Tₐᵥₑ (%) | 82.6 | 84.8 | 2.7 |
| 481 nm to 560 nm | Tₐᵥₑ (%) | 87.1 | 89.3 | 2.5 |
| T50% cut-off (nm) | | 637.2 | 637.6 | — |
| T10% cut-off (nm) | | 681.9 | 681.6 | — |
| 850 nm to 1,050 | Tₐᵥₑ (%) | 28.4 | 28.2 | −0.7 |
| nm | | | | |
| 950 nm | Transmittance | 27.6 | 27 | −2.2 |
| | (%) | | | |
| 1,050 nm | Transmittance | 17.7 | 17.5 | −1.1 |
| | (%) | | | |

### Embodiment 10

An optical filter was prepared by forming a dielectric multilayer film on both surfaces of the optical filter of Embodiment 9. The dielectric multilayer film was formed by depositing sublayers using an ion-beam assisted deposition method. During the deposition, vacuum and temperature conditions were 5.0E-5 Torr and 120° C., respectively, and IBS (Ion Beam Sputtering) source voltage was set to 350 V and current was set to 850 mA. In the above manner, a high refractive index TiO₂ layer (refractive index of about 2.61) and a low refractive index layer of SiO₂ (refractive index of about 1.46) were alternately formed to form a dielectric multilayer film.

Table 7 shows the thickness of each sub-layer of the dielectric multilayer film formed on the surface of the resin layer (transmittance control layer) of the optical filter, and Table 8 shows the thickness of each sub-layer formed on the surface opposite to the formed surface of the resin layer (transmittance control layer) of the glass substrate of the optical filter. In Tables 7 and 8, the number 1 is a layer formed first on the resin layer (transmittance control layer) or the glass substrate.

TABLE 7

| Layer Number | Material | Thickness (nm) |
|---|---|---|
| 1 | SiO₂ | 57.65 |
| 2 | TiO₂ | 8.26 |
| 3 | SiO₂ | 45.13 |
| 4 | TiO₂ | 112.42 |
| 5 | SiO₂ | 182.19 |
| 6 | TiO₂ | 110.05 |
| 7 | SiO₂ | 187.25 |
| 8 | TiO₂ | 112.24 |
| 9 | SiO₂ | 187.43 |
| 10 | TiO₂ | 112.22 |
| 11 | SiO₂ | 188.56 |
| 12 | TiO₂ | 112.01 |
| 13 | SiO₂ | 187.2 |
| 14 | TiO₂ | 111.69 |
| 15 | SiO₂ | 185.94 |
| 16 | TiO₂ | 109.55 |
| 17 | SiO₂ | 181.24 |
| 18 | TiO₂ | 104.95 |
| 19 | SiO₂ | 83.26 |

TABLE 8

| Layer Number | Material | Thickness (nm) |
|---|---|---|
| 1 | SiO₂ | 8.7 |
| 2 | TiO₂ | 35.32 |
| 3 | SiO₂ | 98.86 |
| 4 | TiO₂ | 159.43 |
| 5 | SiO₂ | 90.55 |
| 6 | TiO₂ | 152.34 |
| 7 | SiO₂ | 80.08 |
| 8 | TiO₂ | 148.39 |
| 9 | SiO₂ | 85.96 |
| 10 | TiO₂ | 147.7 |
| 11 | SiO₂ | 83.85 |
| 12 | TiO₂ | 148.51 |
| 13 | SiO₂ | 84.95 |
| 14 | TiO₂ | 146.99 |
| 15 | SiO₂ | 85.15 |
| 16 | TiO₂ | 149.41 |
| 17 | SiO₂ | 85.39 |
| 18 | TiO₂ | 150.27 |
| 19 | SiO₂ | 88.98 |
| 20 | TiO₂ | 156.03 |
| 21 | SiO₂ | 90.32 |
| 22 | TiO₂ | 78.09 |

Table 9 shows the evaluation results of the optical filter. In Table 9, Tₘᵢₙ is the minimum transmittance (unit: %) in the corresponding wavelength region, and Tₐᵥₑ is the average transmittance (unit: %) in the corresponding wavelength region. In Table 9, Ref is a value for an optical filter (i.e., a filter having a structure of dielectric multilayer film/second absorption layer/first absorption layer/glass substrate/dielectric multilayer film) where the resin layer (transmittance control layer) is not formed.

In Table 9, T50% cut-on is the shortest wavelength (unit: nm) showing 50% transmittance within the wavelength range of 350 nm to 425 nm, and T50% cut-off is the longest wavelength (unit: nm) showing a transmittance of 50% within the wavelength range of 600 nm to 900 nm. T10% cut-off is the longest wavelength (unit: nm) showing a transmittance of 10% within the wavelength range of 600 nm to 900 nm.

TABLE 9

| | | | Embodiment 10 | |
|---|---|---|---|---|
| | | | | Rate of |
| | | | Transmittance | Increase/ |
| | | | or | Decrease |
| | | Ref | Wavelength | (%) |
| T50% cut-on (nm) | | 412.4 | 412 | — |
| 425 nm to 465 nm | Tₘᵢₙ (%) | 64 | 64.4 | 0.6 |
| | Tₐᵥₑ (%) | 77 | 78.1 | 1.4 |
| 466 nm to 480 nm | Tₘᵢₙ (%) | 83.5 | 85.7 | 2.6 |
| | Tₐᵥₑ (%) | 85.9 | 87.3 | 1.6 |
| 481 nm to 560 nm | Tₐᵥₑ (%) | 91.4 | 92.2 | 0.9 |
| T50% cut-off (nm) | | 640.5 | 640.4 | |
| T10% cut-off (nm) | | 982.1 | 682.2 | — |
| 850 nm to 1,050 | Tₐᵥₑ (%) | 0 | 0 | — |
| nm | | | | |
| 950 nm | Transmittance | 0 | 0 | — |
| | (%) | | | |
| 1,050 nm | Transmittance | 0 | 0 | — |
| | (%) | | | |

### Embodiment 11

A resin layer (transmittance control layer) was prepared on one surface of the glass substrate in the same manner as in Embodiment 6. The same material as in Embodiment 9 was used as a material for forming the glass substrate and the resin layer. However, during spin-coating of the coating solution for forming the resin layer, the rotational speed was controlled to about 1,500 rpm so that the resin layer had a thickness of about 75.9 nm. Except for changing the thickness of the resin layer, the method of forming the resin layer is the same as in Embodiment 6.

### Embodiment 12

A resin layer (transmittance control layer) was prepared on one surface of the glass substrate in the same manner as in Embodiment 6. The same material as in Embodiment 6 was used as a material for preparing the glass substrate and the resin layer. However, during spin-coating of the coating solution for preparing the resin layer, the rotational speed was controlled to about 1,050 rpm so that the resin layer had a thickness of about 121 nm.

### Embodiment 13

A resin layer (transmittance control layer) was prepared on one surface of the glass substrate in the same manner as in Embodiment 6. The same material as in Embodiment 6 was used as a material for preparing the glass substrate and the resin layer. However, the rotational speed was controlled to about 2,000 rpm during spin-coating of the coating solution for preparing the resin layer. In this case, since the resin layer was formed very thin, it was impossible to measure the thickness.

Table 10 shows the evaluation results for Embodiments 11 to 13. Tₘᵢₙ is the minimum transmittance (unit: %) in the corresponding wavelength region, and Tₐᵥₑ is the average transmittance (unit: %) in the corresponding wavelength region. In Table 10, Ref is a value for a glass substrate where the resin layer (transmittance control layer) is not formed.

TABLE 10

| | | | Embodiment 11 | | Embodiment 12 | | Embodiment 13 | |
|---|---|---|---|---|---|---|---|---|
| | | | | Rate of | | Rate of | | Rate of |
| | | | | Increase/ | | Increase/ | | Increase/ |
| | | Ref | Transmittance | Decrease | Transmittance | Decrease | Transmittance | Decrease |
| 425 nm to | Tₘᵢₙ (%) | 91.1 | 93.4 | 2.5 | 91.2 | 0.1 | 92.6 | 1.6 |
| 465 nm | Tₐᵥₑ (%) | 91.6 | 93.5 | 2.1 | 91.6 | 0 | 92.9 | 1.4 |
| 466 nm to | Tₘᵢₙ (%) | 91.4 | 93.5 | 2.3 | 91.6 | 0.2 | 92.7 | 1.4 |
| 480 nm | Tₐᵥₑ (%) | 91.6 | 93.5 | 2.1 | 91.9 | 0.3 | 92.8 | 1.3 |
| 481 nm to | Tₐᵥₑ (%) | 91.7 | 93.5 | 2.0 | 92.4 | 0.8 | 92.7 | 1.1 |
| 560 nm | | | | | | | | |

### Embodiment 14

A resin layer (transmittance control layer) was prepared on one side of the same glass substrate as used in Embodiment 6. The resin layer was spin-coated with a coating solution in which DBE (dibutyl ether) and inorganic polysilazane (manufacturer: DNF, Product Name: DHC-19D) are mixed in a weight ratio of 8.1:1.9 (DBE:inorganic polysilazane) and was prepared by maintaining it at 140° C. for about 2 hours. During the spin coating, the rotation speed was controlled to about 1,700 rpm so that the resin layer had a thickness of about 29.6 nm.

### Embodiment 15

A resin layer (transmittance control layer) was prepared on one side of the same glass substrate as used in Embodiment 6. The same material as in Embodiment 14 was used as a material for preparing the resin layer. During spin-coating of the coating solution for preparing the resin layer, the rotational speed was controlled to about 1,800 rpm so that the resin layer had a thickness of about 27.1 nm. Except for changing the thickness of the resin layer, the method of forming the resin layer is the same as in Embodiment 14.

### Embodiment 16

A resin layer (transmittance control layer) was prepared on one side of the same glass substrate as used in Embodiment 6. The same material as in Embodiment 14 was used as a material for preparing the resin layer. However, during spin-coating of the coating solution for preparing the resin layer, the rotational speed was controlled to about 2,000 rpm so that the resin layer had a thickness of about 25.1 nm. Except for changing the thickness of the resin layer, the method of preparing the resin layer is the same as in Embodiment 14.

Table 11 is the results for Embodiments 14 to 16. In Table 11, Tin mis the minimum transmittance (unit: %) in the corresponding wavelength region, and Tₐᵥₑ is the average transmittance (unit: %) in the corresponding wavelength region. In Table 11, Ref is a value for a glass substrate where the resin layer (transmittance control layer) is not formed.

TABLE 11

| | | | Embodiment 14 | | Embodiment 15 | | Embodiment 16 | |
|---|---|---|---|---|---|---|---|---|
| | | | | Rate of | | Rate of | | Rate of |
| | | | | Increase/ | | Increase/ | | Increase/ |
| | | Ref | Transmittance | Decrease | Transmittance | Decrease | Transmittance | Decrease |
| 425 nm to | Tₘᵢₙ (%) | 91.1 | 91.7 | 0.7 | 91.5 | 0.4 | 91.7 | 0.7 |
| 465 nm | Tₐᵥₑ (%) | 91.6 | 92.1 | 0.5 | 92.1 | 0.5 | 92.2 | 0.7 |
| 466 nm to | Tₘᵢₙ (%) | 91.4 | 92.1 | 0.8 | 92 | 0.7 | 92 | 0.7 |
| 480 nm | Tₐᵥₑ (%) | 91.6 | 92.2 | 0.7 | 92.3 | 0.8 | 92.2 | 0.7 |
| 481 nm to | Tₐᵥₑ (%) | 91.7 | 92.3 | 0.7 | 92.2 | 0.5 | 92.3 | 0.7 |
| 560 nm | | | | | | | | |

### Embodiment 17

A resin layer (transmittance control layer) was prepared on one side of the same glass substrate as used in Embodiment 6. The same material as in Embodiment 1 was used as a material for preparing the resin layer. However, the rotational speed was controlled to about 1,500 rpm during spin-coating of the coating solution for preparing the resin layer. The method for preparing the resin layer is the same as in Embodiment 1 except that the rotational speed during spin-coating of the resin layer is changed.

### Embodiment 18

A resin layer (transmittance control layer) was prepared on one side of the same glass substrate as used in Embodiment 6. The same material as in Embodiment 1 was used as a material for preparing the resin layer. However, the rotational speed was controlled to about 1,700 rpm during spin-coating of the coating solution for preparing the resin layer. The method for preparing the resin layer is the same as in Embodiment 1 except that the rotational speed during spin-coating of the resin layer is changed.

Table 12 shows the evaluation results for Embodiments 17 and 18. In Table 12, Tₘᵢₙ is the minimum transmittance (unit: %) in the corresponding wavelength region, and Tₐᵥₑ is the average transmittance (unit: %) in the corresponding wavelength region. In Table 12, Ref is a value for a glass substrate where the resin layer (transmittance control layer) is not formed.

TABLE 12

| | | | Embodiment 17 | | Embodiment 18 | |
|---|---|---|---|---|---|---|
| | | | Trans- | Rate of | Trans- | Rate of |
| | | | mit- | Increase/ | mit- | Increase/ |
| | | Ref | tance | Decrease | tance | Decrease |
| 425 nm to | Tₘᵢₙ (%) | 91.1 | 91.9 | 0.9 | 92.2 | 1.2 |
| 465 nm | Tₐᵥₑ (%) | 91.6 | 92.3 | 0.8 | 92.5 | 1.0 |
| 466 nm to | Tₘᵢₙ (%) | 91.4 | 92.3 | 1.0 | 92.3 | 1.0 |
| 480 nm | Tₐᵥₑ (%) | 91.6 | 92.4 | 0.9 | 92.4 | 0.9 |
| 481 nm to | Tₐᵥₑ (%) | 91.7 | 92.5 | 0.9 | 92.4 | 0.8 |
| 560 nm | | | | | | |

### Embodiment 19

As a glass substrate, the same glass substrate as in Embodiment 2 was applied, and a resin layer (transmittance control layer) was prepared on one surface of the glass substrate. At this time, the resin layer was prepared by using the coating solution applied in Embodiment 2. The preparation method and thickness of the resin layer were the same as in Embodiment 2. However, at the time of spin-coating of the coating solution, the rotation speed was adjusted to about 1,050 rpm so that the thickness of the final resin layer was adjusted to about 121 nm. Subsequently, an optical filter was manufactured by sequentially forming a pressure-sensitive adhesive layer and an absorption layer on the surface of the glass substrate where the resin layer (transmittance control layer) was not formed. The pressure-sensitive adhesive layer and the absorption layer were formed in the same manner as in Embodiment 8.

The evaluation results for Embodiment 19 were summarized and described in Table 13. In Table 13, Tₘᵢₙ is the minimum transmittance (unit: %) in the corresponding wavelength region, and Tₐᵥₑ is the average transmittance (unit: %) in the corresponding wavelength region. In Table 13, Ref is the transmittance of the optical filter where the resin layer (transmittance control layer) is not formed. In addition, the numerical values in parentheses in Table 13 are the rate of change (unit: %) compared to Ref.

TABLE 13

| | | Ref | Embodiment 19 |
|---|---|---|---|
| 426 nm to 465 nm | Tₘᵢₙ (%) | 69.3 | 68.5 (−12) |
| | Tₐᵥₑ (%) | 78.8 | 78.1 (−0.9) |
| 466 nm to 480 nm | Tₘᵢₙ (%) | 83.6 | 84.2 (0.7) |
| | Tₐᵥₑ (%) | 85.3 | 85.4 (0.1) |
| 481 nm to 560 nm | Tₐᵥₑ (%) | 86.5 | 88.1 (1.8) |

### Embodiment 20

An optical filter having a structure of glass substrate/first absorption layer/second absorption layer/resin layer was prepared in the same manner as in Embodiment 9. The optical filter was prepared in the same way using the same materials as in Embodiment 9, except that the rotation speed was adjusted to about 1,050 rpm during spin-coating of the coating solution for preparing the resin layer, so that the thickness of the final resin layer was 121 nm.

### Embodiments 21 to 28

An optical filter was prepared in the same manner as in Embodiment 20, except that the rotational speed of the spin-coating and the thickness of the resin layer were changed as shown in Table 14 during preparation of the resin layer. In Embodiment 28, since the resin layer was formed very thin, making it difficult to accurately measure the thickness.

TABLE 14

| | Embodiment | | | | | | | | |
|---|---|---|---|---|---|---|---|---|---|
| | 20 | 21 | 22 | 23 | 24 | 25 | 26 | 27 | 28 |
| Rotation | 1,050 | 1,200 | 1,300 | 1,400 | 1,500 | 1,600 | 1,700 | 1,800 | 2,000 |
| Speed | | | | | | | | | |
| (rpm) | | | | | | | | | |
| Thickness | 121 | 84.9 | 75.3 | 73.6 | 75.9 | 58.1 | 51 | 49.9 | — |
| (nm) | | | | | | | | | |

The evaluation results for Embodiments 20 to 28 were summarized and described in Table 15. In Table 15, Tₘᵢₙ is the minimum transmittance (unit: %) in the corresponding wavelength region, and Tₐᵥₑ is the average transmittance (unit: %) in the corresponding wavelength region. In Table 15, Ref is the transmittance of the optical filter where the resin layer (transmittance control layer) is not formed.

TABLE 15

| | | | Embodiment | | | | | | | | |
|---|---|---|---|---|---|---|---|---|---|---|---|
| | | Ref | 20 | 21 | 22 | 23 | 24 | 25 | 26 | 27 | 28 |
| 425 nm to | Tₘᵢₙ | 61.8 | 63.3 | 63.9 | 64 | 64 | 63.9 | 63.5 | 63.2 | 63 | 62.6 |
| 465 nm | Tₐᵥₑ | 72.6 | 74.3 | 75.1 | 75.1 | 74.9 | 74.8 | 74.9 | 74.7 | 74.4 | 74.1 |
| 466 nm to | Tₘᵢₙ | 78.7 | 80.4 | 81.7 | 81.3 | 81 | 80.9 | 81.9 | 81.7 | 81.4 | 81.2 |
| 480 nm | Tₐᵥₑ | 81.0 | 83.2 | 83.9 | 83.8 | 83.6 | 83.5 | 83.6 | 83.4 | 83 | 82.7 |
| 481 nm to | Tₐᵥₑ | 86.6 | 89.1 | 89.5 | 89.4 | 89.2 | 89 | 88.9 | 88.6 | 88.3 | 88 |
| 560 nm | | | | | | | | | | | |

Table 16 shows the results of converting the results of Table 15 to the increase/decrease rate (unit: %) compared to Ref.

TABLE 16

| | | | Embodiment | | | | | | | | |
|---|---|---|---|---|---|---|---|---|---|---|---|
| | | Ref | 20 | 21 | 22 | 23 | 24 | 25 | 26 | 27 | 28 |
| 425 nm to | Tₘᵢₙ | 61.8 | 2.4 | 3.4 | 3.6 | 3.6 | 3.4 | 2.8 | 2.3 | 1.9 | 1.3 |
| 465 nm | Tₐᵥₑ | 72.6 | 2.3 | 3.4 | 3.4 | 3.2 | 3 | 3.2 | 2.9 | 2.5 | 2.1 |
| 466 nm to | Tₘᵢₙ | 78.7 | 2.2 | 3.8 | 3.3 | 2.9 | 2.8 | 3.9 | 3.8 | 3.4 | 3.2 |
| 480 nm | Tₐᵥₑ | 81.0 | 2.7 | 3.6 | 3.5 | 3.2 | 3.1 | 3.2 | 3 | 2.5 | 2.1 |
| 481 nm to | Tₐᵥₑ | 86.6 | 2.9 | 3.3 | 3.2 | 3.0 | 2.8 | 2.7 | 2.3 | 2. | 1.6 |
| 560 nm | | | | | | | | | | | |

### Embodiment 29

An optical filter was prepared in the same manner as in Embodiment 20, but an optical filter was prepared by changing the stacking order of the optical filter. That is, by changing the structure of Embodiment 20, which is an optical filter having a structure of glass substrate/first absorption layer/second absorption layer/resin layer, an optical filter having a structure of resin layer/glass substrate/first absorption layer/second absorption layer was prepared. Except for changing the stacking order as described above, materials and forming methods for preparing each layer were the same as in Embodiment 20.

### Embodiments 30 to 37

An optical filter was formed in the same manner as in Embodiment 29, except that the rotational speed of the spin-coating and the thickness of the resin layer were changed as shown in Table 17 during preparation of the resin layer. In Embodiment 37, since the resin layer was formed very thin, it was difficult to accurately measure the thickness.

TABLE 17

| | Embodiment | | | | | | | | |
|---|---|---|---|---|---|---|---|---|---|
| | 29 | 30 | 31 | 32 | 33 | 34 | 35 | 36 | 37 |
| Rotation | 1,050 | 1,200 | 1,300 | 1,400 | 1,500 | 1,600 | 1,700 | 1,800 | 2,000 |
| Speed | | | | | | | | | |
| (rpm) | | | | | | | | | |
| Thickness | 121 | 84.9 | 75.3 | 73.6 | 75.9 | 58.1 | 51 | 49.9 | — |
| (nm) | | | | | | | | | |

The evaluation results for Embodiments 29 to 37 were summarized and described in Table 18. In Table 18, Tₘᵢₙ is the minimum transmittance (unit: %) in the corresponding wavelength region, and Tₐᵥₑ is the average transmittance (unit: %) in the corresponding wavelength region. In Table 18, Ref is the transmittance of the optical filter where the resin layer (transmittance control layer) is not formed.

TABLE 18

| | | | Embodiment | | | | | | | | |
|---|---|---|---|---|---|---|---|---|---|---|---|
| | | Ref | 29 | 30 | 31 | 32 | 33 | 34 | 35 | 36 | 37 |
| 425 nm to | Tₘᵢₙ | 60 | 61.2 | 60.9 | 61.2 | 61.1 | 60.9 | 60.5 | 60.1 | 60.2 | 60.5 |
| 465 nm | Tₐᵥₑ | 71.6 | 72.8 | 72.9 | 72.7 | 73 | 72.7 | 72.6 | 72.4 | 72.3 | 72.2 |
| 466 nm to | Tₘᵢₙ | 78.6 | 79.3 | 79.6 | 78.9 | 80.4 | 79.5 | 79.6 | 80 | 79.8 | 79 |
| 480 nm | Tₐᵥₑ | 80.6 | 82 | 82 | 81.7 | 81.8 | 81.6 | 81.6 | 81.6 | 81.5 | 81.3 |
| 481 nm to | Tₐᵥₑ | 86.6 | 87.9 | 87.7 | 87.5 | 87.5 | 87.3 | 87.3 | 87.3 | 87.2 | 87 |
| 560 nm | | | | | | | | | | | |

The results of converting the results of Table 18 to the rate of increase/decrease (unit: %) compared to Ref are shown in Table 19.

TABLE 19

| | | | Embodiment | | | | | | | | |
|---|---|---|---|---|---|---|---|---|---|---|---|
| | | Ref | 29 | 30 | 31 | 32 | 33 | 34 | 35 | 36 | 37 |
| 425 nm to | Tₘᵢₙ | 60 | 2 | 1.5 | 2 | 1.8 | 1.5 | 0.8 | 0.2 | 0.3 | 0.8 |
| 465 nm | Tₐᵥₑ | 71.6 | 1.7 | 1.8 | 1.5 | 2 | 1.5 | 1.4 | 1.1 | 1 | 0.8 |
| 466 nm to | Tₘᵢₙ | 78.6 | 0.9 | 1.3 | 0.4 | 2.3 | 1.1 | 1.3 | 1.8 | 1.5 | 0.5 |
| 480 nm | Tₐᵥₑ | 80.6 | 1.7 | 1.7 | 1.4 | 1.5 | 1.2 | 1.2 | 1.2 | 1.1 | 0.9 |
| 481 nm to | Tₐᵥₑ | 86.6 | 1.5 | 1.3 | 1 | 1 | 0.8 | 0.8 | 0.8 | 0.7 | 0.5 |
| 560 nm | | | | | | | | | | | |

1. An optical filter comprising:
a substrate; and
a transmittance control layer formed on one or both surfaces of the substrate wherein an absolute value of a difference in a refractive index of the transmittance control layer with respect to a refractive index of the substrate is in a range of 2% to 10% and ΔT₁ is 0.5% or more in Equation 1:
$$Δ {T}_{1} = 100 \times ( {T}_{F 1} - {T}_{S 1} ) / {T}_{S 1} \qquad [ Equation 1 ]$$
In Equation 1, wherein T_{F1} is an average transmittance in a wavelength range of 481 nm to 560 nm of the optical filter, and T_{S1} is an average transmittance in the wavelength range of 481 nm to 560 nm of the optical filter not including the transmittance control layer.

2. The optical filter of claim 1, wherein T_{F1} in Equation 1 is 80% or more.

3. The optical filter of claim 1, wherein the substrate is a glass substrate.

4. The optical filter of claim 3, wherein the glass substrate contains copper in an amount of about 10% by weight or less.

5. The optical filter of claim 1, wherein the transmittance control layer comprises at least one selected from a group consisted of a cyclic olefin polymer resin (COP), polyarylate, polyisocyanate, polyimide, polyetherimide, polyamideimide, polyacrylate, polyester, polysulfone, polysilazane, and polysiloxane.

6. The optical filter of claim 1, wherein the refractive index of the substrate is greater than the refractive index of the transmittance control layer and the refractive index of the substrate is in the range of about 1.48 to 1.6.

7. The optical filter of claim 1, wherein the transmittance control layers are formed on both sides of the substrate.

8. The optical filter of claim 1, further comprising a light absorption layer.

9. The optical filter of claim 8, wherein an absolute value of a difference in a refractive index of the light absorption layer with respect to the refractive index of the substrate is in a range of about 0.2% to 10%.

10. The optical filter of claim 8, further comprising a pressure-sensitive adhesive layer, an adhesive layer, or a primer layer between the light absorption layer and the substrate.

11. The optical filter of claim 10, wherein the transmittance control layer is located on a surface opposite to the surface of the substrate on which the pressure-sensitive adhesive layer, the adhesive layer, or the primer layer is formed.

12. The optical filter of claim 10, wherein the transmittance control layer is located on a surface opposite to the surface of the light absorption layer on which the pressure-sensitive adhesive layer, the adhesive layer, or the primer layer is formed.

13. The optical filter of claim 10, wherein a difference in the refractive index of the light absorption layer with respect to the refractive index of the substrate is in a range of about 0.2% to 2%; a difference in a refractive index of the pressure-adhesive adhesive layer, the adhesive layer, or the primer layer with respect to the refractive index of the substrate is in a range of about 3% to 10%; and a difference in the refractive index of the pressure-sensitive adhesive layer, the adhesive layer, or the primer layer with respect to the refractive index of the transmittance control layer is within a range of about 8% to 15%.

14. The optical filter of claim 10, wherein a difference in the refractive index of the transmittance control layer with respect to the refractive index of the substrate is in a range of about −2% to −10%.

15. The optical filter of claim 10, wherein the light absorption layer is in direct contact with the pressure-sensitive adhesive layer, the adhesive layer, or the primer layer each other; the substrate is in direct contact with the pressure-sensitive adhesive layer, the adhesive layer, or the primer layer each other; and the transmittance control layer is in direct contact with the light absorption layer or the substrate.

16. The optical filter of claim 8, wherein the light absorption layers comprise a first and a second light absorption layers having different refractive indices each other wherein the transmittance control layer is formed on a surface opposite to the surface of the substrate on which the first light absorption layer is formed.

17. The optical filter of claim of 16, wherein the transmittance control layer is formed on a surface of the second light absorption layer opposite to the surface on which the first light absorption layer is formed.

18. The optical filter of claim 16, wherein the first light absorption layer has a lower refractive index than the second light absorption layer and the first light absorption layer is located between the second light absorption layer and the substrate.

19. The optical filter of claim 16, wherein a difference in the refractive index of the first light absorption layer with respect to the refractive index of the substrate is in a range of about −2% to −10% and a difference in the refractive index of the second light absorption layer with respect to the refractive index of the substrate is in a range of about 2% to 10%.

20. The optical filter of claim 16, wherein a difference in the refractive index of the transmittance control layer with respect to the refractive index of the substrate is in a range of about −2% to −10%.
